(19) United States
(12) Patent Application Publication
(10) Pub. No.: US 2008/0145297 A1
(43) Pub. Date: Jun. 19, 2008

(54) Fuel Processor, Components Thereof and Operating Methods Therefor

(76) Inventors: Erik Paul Johannes, Burnaby (CA); Jacobus Neels, Rosedale (CA); Xuantian Li, Vancouver (CA); Richard Allan Sederquist, Middletown, CT (US)

Correspondence Address: MCANDREWS HELD & MALLOY, LTD, 500 WEST MADISON STREET, SUITE 3400, CHICAGO, IL, 60661, US

(21) Appl. No.: 11/935,282

(22) Filed: Nov. 5, 2007

Related U.S. Application Data
(60) Provisional application No. 60/864,319, filed on Nov. 3, 2006.
(60) Provisional application No. 60/864,240, filed on Nov. 3, 2006.
(60) Provisional application No. 60/864,248, filed on Nov. 3, 2006.
(60) Provisional application No. 60/915,116, filed on May 1, 2007.
(60) Provisional application No. 60/954,803, filed on Aug. 8, 2007.

(51) Int. Cl. C01B 3/02; B01J 19/00; C01B 31/18; F01N 3/00

(52) U.S. Cl. 423/418.2; 422/129; 423/648.1; 422/224; 422/198; 123/3; 60/286

(57) ABSTRACT

Fuel processors include at least one of a fuel introduction tube, a critical flow venturi and/or a heat exchanger along with other components. Such fuel processors are particularly suitable for use in engine system applications where a liquid fuel is introduced into an oxidant stream comprising hot engine exhaust gas, for downstream conversion in the fuel processor to produce a hydrogen-containing gas stream, such as a syngas stream.

### CROSS-REFERENCE TO RELATED APPLICATION(S)

This application is related to and claims priority benefits from U.S. Provisional Patent Application Ser. No. 60/864,319 filed Nov. 3, 2006, entitled “System And Method For Introducing A Fuel Stream Into An Engine Exhaust Stream”; Ser. No. 60/864,240 filed Nov. 3, 2006, entitled “Syngas Generator With Metering, Mixing And Flashback Arresting Device”; Ser. No. 60/864,248 filed Nov. 3, 2006, entitled “System And Method For Mixing A Fuel Stream And An Engine Exhaust Stream In A Fuel Processor”; Ser. No. 60/915,116 filed May 1, 2007, entitled “Syngas Generator”; and Ser. No. 60/954,803 filed Aug. 8, 2007, entitled “Syngas Generator”, each of which is hereby incorporated by reference in its entirety.

### FIELD OF THE INVENTION

The present invention relates to fuel processors for producing a hydrogen-containing gas stream. The improved fuel processor includes at least one of a fuel introduction tube, a critical flow venturi or a heat exchanger along with other components. The present apparatus and methods are particularly suitable for fuel processors that are used in engine system applications, where a liquid fuel is introduced into an oxidant stream comprising hot engine exhaust gas for downstream conversion into a hydrogen-containing gas stream, such as a syngas stream.

### BACKGROUND OF THE INVENTION

Governments have legislated emissions regulations to reduce the exhaust emissions from internal combustion engines. To meet upcoming regulations, new exhaust after-treatment solutions are being developed, especially in the diesel industry. Some of the exhaust after-treatment devices include Lean NOx Traps (LNT), Diesel Particulate Filters (DPF) and Diesel Oxidation Catalysts (DOC). These devices can require periodic in situ regeneration, desulfation and/or heating to maintain their desired performance.

A hydrogen-containing gas can be used to regenerate, desulfate and/or heat such engine exhaust after-treatment devices. In vehicular or other mobile applications, the supply of hydrogen is preferably produced on-board. The required hydrogen-containing gas can be produced by various methods such as introducing a hydrocarbon fuel directly into the engine exhaust stream upstream of the after-treatment devices (so that hydrogen is formed in situ within the after-treatment device), or with the use of a fuel processor, such as a syngas generator (SGG), in which a syngas stream comprising hydrogen and carbon monoxide is produced and then directed to the after-treatment device. A portion of the engine exhaust stream can be used as an oxidant for the fuel conversion process. The exhaust stream typically contains oxygen (O₂), water (H₂O), carbon dioxide (CO₂), nitrogen (N₂) and sensible heat, which can be useful for the production of syngas. Additional air can optionally be added. The fuel supplied to the SGG can conveniently be chosen to be the same fuel that is supplied to the engine. Alternatively a different fuel can be used, although this would generally require a separate secondary fuel source and supply system specifically for the SGG. In vehicular or other mobile applications, the on-board SGG should generally be low cost, compact, light-weight and efficiently packaged with other components of the engine system.

Syngas production can be segregated into three main processes: mixing, oxidizing and reforming, as illustrated in FIG. 1. The first process is the mixing process and it generally takes place at or near the inlet, where the oxidant and fuel streams are introduced into the SGG, in the so-called “mixing zone”. The primary function of the mixing process is to supply an evenly mixed and distributed fuel-exhaust gas mixture for subsequent combustion and reformation. If the fuel is a liquid it is typically atomized and vaporized, as well as being mixed with engine exhaust in this zone. The next process, the oxidizing process, takes place downstream of the mixing zone, in the so called “combustion zone”. The primary function of the oxidizing process is to ignite the fuel-oxidant mixture to produce H₂ and CO as primary products as well as the sensible heat required for the downstream endothermic reformation reactions. The final process, the reforming process, is where the oxidation products and remaining fuel constituents are further converted to hydrogen and carbon monoxide via reforming reactions. The syngas stream then exits the SGG and is directed to the appropriate exhaust after-treatment device for regeneration, desulfation and/or heat production. There is not strict separation between the zones; rather the zones transition or merge into one another, but the primary processes happening in each of the zones are as described above.

For proper functioning of the fuel processor in engine system applications, and in other fuel processor applications, the supply of both the fuel and the oxidant streams should be suitably metered or controlled. Also there should be adequate mixing of the two reactant streams, as well as adequate atomization and vaporization of the fuel if it is a liquid. Furthermore, since there is combustible mixture within the fuel processor, preferably there is some means of mitigating the risk of flashback. Flashback is uncontrolled combustion that can occur and propagate back from the combustion zone into to the mixing zone in the fuel processor. Some of the conventional techniques that have been used for reactant metering, mixing and flashback arrest in various fuel processor applications are described below.

Reactant Metering. Mechanical or electrical valves, controls, sensors or combinations are typically used to meter or regulate the mass flow of reactant streams directed to a fuel processor. A controller, using signals from sensors and/or pre-programmed logic to transmit a signal to a valve actuator, is commonly used to open, close or adjust the valve thereby metering the flow of a reactant. However, such “active” reactant metering systems, with multiple moving and interconnected components, typically add to the overall complexity and cost of the system; reduce system reliability and durability; increase the likelihood of fluid leakage; and slow the dynamic response time of the fuel processor.

Liquid Fuel Supply and Mixing. Conversion of liquid fuels, especially heavy hydrocarbons, can be difficult due to the various components that make up the fuel that react at different temperatures and rates. Inadequate vaporization and mixing of the fuel with the oxidant stream can lead to localized fuel-rich conditions, resulting in the formation of coke or soot (carbon), and can also adversely affect the fuel conversion efficiency. Chemical decomposition of the fuel can also lead to carbon formation starting at temperatures as low as about 200° C. Carbon deposits can impede the flow of gases in the fuel processor and downstream devices, increasing the back pressure in the system.

Liquid fuel is typically sprayed into the hot engine exhaust gas or oxidant stream through a nozzle. As the liquid fuel is sprayed, the fuel stream is broken into droplets or atomized and forced into the exhaust gas stream over a wide spray pattern. The temperature of the engine exhaust stream can reach over 600° C., but at such elevated temperatures there is a limited time in which to effectively vaporize and mix the two streams before undesirable carbon forming reactions will start to occur. Furthermore the wide spray pattern can cause fuel to be sprayed onto the interior walls of the fuel processor creating a “wall wetting” effect that can create undesirable localized fuel-rich conditions.

Prior devices that have been used to introduce a liquid fuel into hot oxidant streams, such as hydraulic nozzles, air-assist nozzles and injectors, suffer from additional shortcomings. There is typically a high pressure drop across such devices, thus significant fuel supply pressure and energy is required. They can be fouled and/or plugged up by various solids and deposits, resulting in increasing pressure drop over time. Also they typically have a limited turndown ratio, plus they can be expensive, heavy and/or bulky. Under high temperature conditions internal fuel boiling within the device can interrupt the flow of fuel through it. Furthermore, the higher mass flow rates typical of prior devices are not necessarily suitable for applications requiring relatively low volume hydrogen production.

Flashback Arrest. A flashback arrestor or flame arrestor is a safety device that inhibits or prevents a flame from propagating back toward the fuel source. Known flashback arrest methodologies include creating a gas speed higher than the flame speed of the combustible mixture; using a pressure sensitive check valve; or using a heat absorbing device to absorb the heat from the combustible mixture. The use of valves or heat absorbing devices can add to the pressure drop across the fuel processor, as well as to the system cost, weight and complexity.

Fuel Processors in Engine System Applications. There are some particular challenges associated with the design of fuel processors used in engine systems to convert a fuel and oxidant stream comprising engine exhaust into a hydrogen-containing stream. These challenges mean that, at least for this application, some of the conventional techniques described above for reactant metering, liquid fuel introduction, reactant mixing and for flashback arrest have shortcomings. The challenges include the following:
(a) The engine exhaust stream output parameters, such as mass flow, pressure, temperature, composition and emission levels, vary significantly over the operating range of the engine. Metering the engine exhaust stream supplied to the fuel processor is therefore a challenge due to the significantly variable exhaust gas supply.
(b) The engine exhaust stream pressure is limited, especially at idle conditions, so the pressure available to aid in the mixing and distribution of fuel in the engine exhaust stream is sometimes limited.
(c) High engine exhaust back-pressure can decrease engine efficiency and performance, increasing the operating cost. The pressure drop across the fuel processor and its associated components is therefore preferably kept low.
(d) The output required from the fuel processor is typically variable.
(e) High system reliability and durability are required.
(g) The internal combustion engine exhaust after-treatment market has cost, volume, and weight constraints, particularly for vehicular applications.

The present fuel processor with improved components and operating methods is effective in addressing at least some of the issues discussed above, both in engine system applications and in other fuel processor applications.

### SUMMARY OF THE INVENTION

Fuel Processors Comprising a Fuel Introduction Tube, Systems Incorporating Such Fuel Processors, and Methods for Operating Such Fuel Processors and Systems.

A fuel introduction tube can be used to introduce a liquid fuel stream (herein meaning a fuel that is a liquid when under IUPAC defined conditions of standard temperature and pressure) into an oxygen-containing gas stream which is at a temperature above the boiling point of the liquid fuel, for downstream chemical conversion in a fuel processor. In preferred embodiments, the fuel introduction tube is thermally shielded from the hot oxygen-containing gas stream to reduce boiling of the fuel which would otherwise occur within the fuel introduction tube, and preferably to maintain the liquid fuel stream below its boiling point within the introduction tube.

A fuel processor assembly for producing a hydrogen-containing fluid stream comprises an oxidant stream inlet and at least one fuel introduction tube for directing a liquid fuel stream from a fuel source into the fuel processor. In preferred embodiments, the fuel introduction tube comprises thermal shielding for maintaining the liquid fuel stream below its boiling point while it is passing through the fuel introduction tube during operation of the fuel processor.

A method of operating a fuel processor comprises introducing a liquid fuel stream into an oxygen-containing gas stream via a fuel introduction tube, wherein the temperature of the oxygen-containing gas stream is above the boiling point of the liquid fuel stream. The fuel stream is maintained below its boiling point while it is in the fuel introduction tube, for example, by passively or actively thermally shielding the fuel introduction tube from the hot oxygen-containing gas stream. An embodiment of the method with active thermal shielding of the tube comprises flowing a thermal shielding fluid in contact with the fuel introduction tube. The thermal shielding fluid is at a temperature below the boiling point of the liquid fuel stream.

The above-described apparatus and method relating to use of a fuel introduction tube to introduce a liquid fuel stream into an oxygen-containing gas stream can advantageously used in engine systems that incorporate a fuel processor, such as a syngas generator, for producing a hydrogen-containing gas stream, such as a syngas stream. For example, such an engine system can comprise a combustion engine connected to receive a fuel stream from a liquid fuel source. The combustion engine has an exhaust stream outlet. The fuel processor comprises an inlet fluidly connected to the engine exhaust stream outlet, such that at least a portion of the engine exhaust stream is directed to the fuel processor during operation of the combustion engine. The fuel processor further comprises at least one fuel introduction tube for directing a liquid fuel stream from a fuel source into the engine exhaust stream. The fuel source is preferably the same for the engine and the fuel processor, but can be different. In preferred embodiments the at least one fuel introduction tube is thermally shielded from the engine exhaust stream.

Methods of operating such engine systems, comprising a combustion engine and a fuel processor, can comprise directing an engine fuel stream and an oxidant stream to the combustion engine and operating the combustion engine to produce an engine exhaust stream. At least a portion of the engine exhaust stream, and optionally a supplemental air stream, is directed to the fuel processor as an oxidant stream. A liquid fuel stream is introduced into the oxidant stream (comprising engine exhaust gas) via a fuel introduction tube, to form a combined reactant stream, and the fuel processor is operating to produce a hydrogen-containing gas stream from the combined reactant stream.

Typically, at least some of the time during operation of the engine system, the temperature of the oxidant stream is higher than the boiling point of the liquid fuel stream. The temperature of the liquid fuel is preferably maintained below its boiling point within the fuel introduction tube by passively or actively thermally shielding the fuel introduction tube. An embodiment of the method with active thermal shielding of the tube comprises flowing a thermal shielding fluid in contact with the fuel introduction tube. The thermal shielding fluid is at a temperature below the temperature of the oxygen-containing gas stream, and preferably below the boiling point of the liquid fuel stream.

It is convenient if the engine fuel stream is drawn from the same source as the liquid fuel stream that is directed to the fuel processor, although it need not be. The liquid fuel stream can be directed to the fuel introduction tube at low pressure, utilizing the fuel supply system of the engine.

In embodiments of the above described methods of operating engine systems comprising a combustion engine and a fuel processor, the degree of fuel stream atomization occurring as the liquid fuel stream is introduced into the oxidant stream comprising engine exhaust, via the introduction tube, is substantially independent of the pressure of the liquid fuel stream supplied to the fuel introduction tube and/or is substantially unaffected by the liquid fuel stream mass flow rate through the fuel introduction tube.

In the above-described fuel processor assembly and engine system embodiments, the fuel introduction tube can have a passive or active thermal shielding mechanism associated therewith. In some embodiment the thermal shielding of the fuel introduction tube can comprise a thermal insulating sleeve disposed around the fuel introduction tube. There can be an air gap between the sleeve and the tube. In actively shielded embodiments, an apparatus or mechanism for flowing a thermal shielding fluid in contact with the fuel introduction tube can be provided. For example, the thermal shielding fluid can be directed to flow between the fuel introduction tube and a sleeve disposed around the fuel introduction tube.

In preferred embodiments of the above-described methods for operating a fuel processor and operating an engine system using a fuel introduction tube, the divergent angle of the fuel stream as it exits the fuel introduction tube is less than about 10° from the longitudinal axis of the fuel introduction tube; the liquid fuel stream speed within the fuel introduction tube is between about 0.1 m/s (0.33 ft/s) and about 10.0 m/s (32.8 ft/s); and/or the pressure drop across the fuel introduction tube is less that about 690 kpag (100 psig), and preferably less than about 69 kpag (10 psig).

Fuel Processors Comprising a Critical Flow Venturi, Systems Incorporating Such Fuel Processors, and Methods for Operating Such Fuel Processors and Systems.

A method of operating a fuel processor comprises directing a reactant stream through a venturi for downstream chemical conversion to produce a hydrogen-containing gas stream. The venturi is capable of operating as a critical flow venturi. In particular, it is capable of operating as a critical flow venturi during the designed or anticipated normal operating range of the fuel processor. At least a portion of the time during operation of the fuel processor, the reactant stream is choked as it passes through the venturi. Preferably the venturi is operated under a choked condition during a predominant portion of the time during operation of the fuel processor to produce the hydrogen-containing gas stream. For example, in some embodiments of the method it can be choked at least 85% of the time. In some embodiments of the method, the speed of the reactant stream through the venturi is in the range from about 300 m/s (984 ft/s) to about 700 m/s (2,297 ft/s).

The reactant stream directed through the venturi can be a single reactant stream to which one or more other reactants are added downstream or can be a mixture comprising, for example, a fuel stream and an oxidant stream. In some embodiments, the fuel stream is a liquid when at standard temperature and pressure, for example, it could be diesel or gasoline. The oxidant stream can be an oxygen-containing gas stream such as air, and in some embodiments comprises, or consists essentially of, engine exhaust gas from a combustion engine. In some embodiments, the reactant stream that is directed through the venturi comprises substantially all of the oxidant stream that is supplied to the fuel processor during operation thereof, so that no additional oxidant stream is added downstream of the venturi.

The supply of a reactant stream to the fuel processor can be passively metered by directing it through the venturi. Thus, the need for active flow control devices associated with the fuel processor can be reduced or eliminated at least for one of the reactants.

In certain embodiments of the method, a predominant portion of the time during operation of the fuel processor, the speed of the reactant stream as it passes through the venturi is greater than the flame speed of the reactant mixture that is in the fuel processor downstream of the venturi.

In certain embodiments, a fuel processor for producing a hydrogen-containing gas stream, comprises a unitary device, in particular a critical flow venturi, capable of metering a reactant stream supplied to the fuel processor, mixing a fuel stream with an oxidant stream, and arresting flashback from downstream combustion of the mixed fuel and oxidant streams within the fuel processor.

In other embodiments, a fuel processor for producing a hydrogen-containing gas stream comprises a venturi having a convergent inlet section and a throat, and further comprises a divergent section located immediately downstream of the venturi throat. There is a step that forms a discontinuity (a sudden increase in flow cross-sectional area) between the throat and the divergent outlet section. The divergent section and the step can be part of the venturi or the step can be at the interface between the venturi and another component, such as a mixing tube that incorporates the divergent section.

The above-described method and apparatus can be advantageously used in engine systems that incorporate a fuel processor, such as a syngas generator, for producing a hydrogen-containing gas stream, such as a syngas stream. Such engine systems comprise a fuel source and a combustion engine connected to receive a fuel stream from the fuel source. The combustion engine has an exhaust stream outlet. The fuel processor comprises a venturi that is fluidly connected to the engine exhaust stream outlet, such that at least a portion of the engine exhaust stream can be directed to the fuel processor via the venturi during operation of the combustion engine. The venturi is preferably capable of operating as a critical flow venturi. In particular, it is capable of operating as a critical flow venturi during the designed or anticipated normal operating range of the fuel processor. In preferred embodiments of the system, the fuel processor comprises a single oxidant stream inlet located upstream of the venturi, via which the engine exhaust stream is introduced without downstream addition of supplemental oxidant streams.

The venturi is preferably also fluidly connected to receive a fuel stream from the same fuel source (or less preferably from a secondary fuel source). The venturi is preferably capable of mixing the engine exhaust stream and the fuel stream. Preferably the venturi is also capable of arresting flashback from downstream combustion of the engine exhaust stream and the fuel stream within the fuel processor.

In preferred embodiments of the engine system there is no flow metering device between the exhaust stream outlet and the venturi for controlling the flow rate of engine exhaust stream directed to the fuel processor. Instead the venturi is capable of passively metering the supply of engine exhaust stream to the fuel processor.

Embodiments of an engine system can further comprise an exhaust after-treatment subsystem, with the fuel processor connected to at least intermittently supply the hydrogen-containing gas stream to the exhaust after-treatment subsystem.

Fuel Processors Comprising a Heat Exchanger Along with a Critical Flow Venturi, Systems Incorporating Such Fuel Processors, and Methods for Operating Such Fuel Processors and Systems.

A fuel processor comprises a heat exchanger for pre-heating a reactant stream using heat from the fuel processor. The reactant stream is pre-heated and then directed through a critical flow venturi for downstream conversion to a hydrogen-containing gas stream. The use of the heat exchanger in combination with the critical flow venturi provides some self-regulation of the operating temperature of the fuel processor. The fuel processor can optionally comprise other components as described below.

In preferred embodiments, a fuel processor for producing a product stream from a fuel and an oxidant stream comprises a fuel inlet port, an oxidant inlet port, and product outlet port, as well as an outer shell housing a reaction chamber. The fuel processor further comprises:
(a) a critical flow venturi fluidly connected to receive the oxidant stream from the oxidant inlet port, via which the oxidant stream is directed from the oxidant inlet port toward the reaction chamber; and
(b) a heat exchanger fluidly connected between the oxidant inlet port and the critical flow venturi for transferring heat from the product stream to the oxidant stream upstream of the critical flow venturi.

The critical flow venturi (CFV) is a venturi capable of operating under a choked condition accelerating the speed of the oxidant stream passing through it to sonic speeds. The product stream, as it flows in contact with the heat exchanger, can contain some unreacted fuel and/or oxidant. The heat exchanger is preferably housed within the outer shell of the fuel processor, at least partially in the reaction chamber. The heat exchanger can be, for example, of a coiled tube type or can comprise a plurality of concentric sleeve structures configured along a longitudinal axis.

The product stream is a hydrogen-containing gas stream. In one variation the fuel processor is a syngas generator and the product stream is a syngas stream comprising hydrogen and carbon monoxide. In one application, the fuel processor can be deployed in an engine system comprising a combustion engine and at least one exhaust after-treatment device with the oxidant inlet port of the fuel processor connected to receive at least a portion of the engine exhaust gas, and the product outlet port connected to at least periodically supply the product stream to at least one exhaust after-treatment device and/or other hydrogen consuming devices within the system, such as fuel cells (not shown) and/or to the engine itself.

The fuel processor can further comprise one or more of the following components:
(i) a fuel introduction tube for introducing a fuel into the oxidant stream, the fuel introduction tube fluidly connected to receive the fuel stream via the fuel inlet port. The fuel introduction tube is particularly suitable for the introduction of liquid fuels.
(ii) a mixing tube located downstream of the CFV, for mixing the fuel stream with the oxidant stream. Preferably at least one of the CFV and the mixing tube comprises a divergent section for pressure recovery. The mixing tube can comprise active or passive thermal shielding for thermally shielding the mixing tube from the high temperatures in the reaction chamber.
(iii) at least one ignition source that in some embodiments is located within the reaction chamber. Shielding can be employed to decrease the speed of the reactant streams around the ignition source or to protect them from radiant heat from the reaction process. Examples of suitable ignition sources include one or more of a glow plug, a spark igniter, or an electrical resistance wire.
(iv) a bluff body located near the entrance to the reaction chamber, for example at least partially in the mixing tube if present.
(v) a filter for trapping carbon particulates. The filter can be housed within the outer shell and located at least partially within or downstream of the reaction chamber.

The reaction chamber of the fuel processor can be thermally insulated, for example, using a thermal insulation material. This material can be interposed between the reaction chamber and the outer shell of the fuel processor. It can comprise a plurality of layers with different thermal conductivity characteristics. Suitable insulation materials include ceramic materials, vacuum-formed materials, and high temperature ceramic mat. Thermal insulation comprising one or more layers of vacuum-formed materials can be advantageously used in other types of fuel processor as well as those described herein

If present, the fuel introduction tube and the mixing tube can each be housed within the fuel processor outer shell or can be located external to the outer shell or main housing.

A method of operating a fuel processor, comprising a heat exchanger, to produce a product stream, comprises:
(a) introducing an oxidant stream into the fuel processor;
(b) directing the oxidant stream through a heat exchanger in which heat is transferred from the product stream to the oxidant stream to produce a pre-heated oxidant stream;
(c) directing the pre-heated oxidant stream through a venturi, wherein at least a portion of the time during operation of the fuel processor, the venturi is choked;
(d) introducing a fuel stream into the pre-heated oxidant stream to produce a combined reactant stream;
(e) converting the combined reactant stream to the product stream within a reaction chamber in the fuel processor.

In preferred embodiments, during step (b) the oxidant stream flows through the heat exchanger in an essentially co-flow direction in relation to the product stream, although it can flow in a counter-flow or other configuration. The product stream, as it flows in contact with the heat exchanger, can contain some unreacted fuel and/or oxidant. Preferably the venturi is operated at a choked condition for a predominant portion of the time during normal operation of the fuel processor. The combined reactant stream can be directed to the reaction chamber via a mixing tube. The mixing tube can house the sonic shock wave when the venturi is choked, and can be used to prolong the mixing duration (and vaporization duration if applicable) of the fuel and oxidant streams upstream of the reaction chamber.

In one variation of the method, the fuel stream is introduced into the pre-heated oxidant stream upstream of the throat of the venturi, whereby it is the combined stream comprising both the fuel and oxidant stream that is directed through the venturi. In another variation of the method the fuel is a liquid fuel and the liquid fuel is introduced into the oxidant stream via a fuel introduction tube.

The combined reactant stream can be directed past a bluff body into the reaction chamber where it is converted to the product stream. The bluff body can modify the flow characteristics of the combined reactant stream as it enters the reaction chamber. For example, it can increase the speed of the combined reactant stream upstream of the reaction chamber or near the exit of the mixing tube to prevent flashback, and/or can help redistribute the combined reactant stream as it enters the reaction chamber and create a reflux zone downstream of it to stabilize the flame.

The method can further comprise directing the product stream (which again can contain some unreacted fuel and/or oxidant) through a filter to trap carbon particulates. The filter is preferably located within the fuel processor. These embodiments of the method can further comprise at least periodically gasifying the carbon particulates thereby cleaning the filter.

At least one ignition source can be used to ignite the combined reactant stream in the reaction chamber and to initiate the conversion process, wherein the ignition source is activated at least periodically during operation of the syngas generator to stabilize the location of the flame of the combined reactant stream.

The above described embodiments of the method of operating a fuel processor comprising a heat exchanger are particularly suitable for engine system applications where the oxidant stream comprises exhaust gas from an internal combustion engine. The product hydrogen-containing gas stream can be directed to one or more exhaust after-treatment devices and/or other hydrogen consuming devices within the system, such as fuel cells (not shown) and/or to the engine itself.

### BRIEF DESCRIPTION OF THE DRAWINGS

FIG. 1 is a process flow chart illustrating a typical fuel conversion process in a syngas generator.

FIG. 2 is a schematic cross-sectional view of an embodiment of a passively thermally shielded introduction tube assembly, located in an oxidant stream upstream of the mixing zone in a fuel processor

FIG. 3 is a schematic cross-sectional view of an embodiment of an air-shielded introduction tube assembly.

FIG. 4 shows cross-sectional views of other embodiments of introduction tube and mixing tube configurations. FIG. 4a shows an angled introduction tube. FIG. 4b shows an angled tube and fuel stream. FIG. 4c shows an off-center introduction tube.

FIG. 5 is a cross-sectional view of a fuel processor embodiment with multiple introduction tubes.

FIG. 6 is a graph of the operating regime of a conventional venturi and a critical flow venturi (CFV), illustrating the relationship between the mass flow of a fluid stream through the venturi and inlet pressure.

FIG. 7 is a cross-sectional view of an embodiment of a CFV incorporated in the inlet region of a fuel processor.

FIG. 8 is a cross-sectional view of an embodiment of a CFV, illustrating its various zones and profiles.

FIG. 9 is a schematic process flow diagram of an embodiment of an internal combustion engine system with a fuel processor and an exhaust after-treatment system.

FIG. 10a is a transparent view of an embodiment of a syngas generator comprising a heat exchanger, fuel introduction tube, CFV, mixing tube, bluff body and particulate filter.

FIG. 10b is a cross-sectional view of the syngas generator illustrated in FIG. 10a.

FIG. 11a is a cross-sectional view of an embodiment of a bluff body with a pilot hole.

FIG. 11b is a cross-sectional view of an embodiment of a bluff body with a layer of catalyst.

FIG. 12a is a front view of another embodiment of a syngas generator, a heat exchanger, fuel introduction tube, CFV, mixing tube and particulate filter, illustrating a turn-around flow design.

FIG. 12b is a cross-sectional view of the syngas generator illustrated in FIG. 12a.

### DETAILED DESCRIPTION OF PREFERRED EMBODIMENT(S)

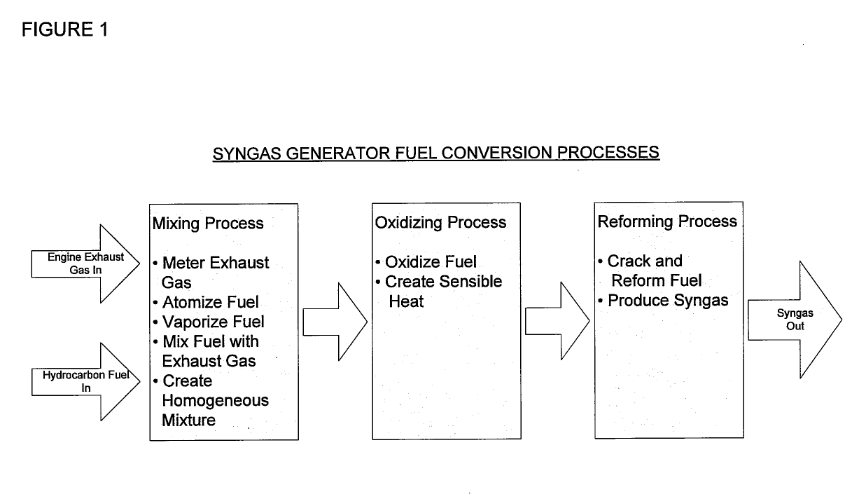

FIG. 1 illustrates a typical syngas generator (SGG) fuel conversion process, and is described above.

### Embodiments Comprising a Fuel Introduction Tube

The present apparatus comprising a fuel introduction tube is particularly suited for introducing liquid fuels into hot oxygen-containing gas streams for downstream chemical conversion in a fuel processor. In situations where the temperature of the hot gas stream exceeds the boiling point of the liquid fuel at least some of the time during operation of the fuel processor, preferably the fuel introduction tube comprises thermal shielding. Similarly, methods of introducing a liquid fuel into a hot oxygen-containing gas stream comprise utilizing a fuel introduction tube as described herein. The fuel introduction tube can be passively or actively thermally shielded to reduce boiling of the fuel within the introduction tube, and preferably to maintain the liquid fuel stream below its boiling point within the fuel introduction tube.

The boiling point of a liquid is the temperature at which the vapor pressure of the liquid equals the environmental pressure surrounding the liquid. Fuels such as diesel and gasoline typically boil over a temperature range as they are made up of a variety of components. As used herein the term “boiling point” refers the temperature at which the fuel stream would begin to boil (also known as the “initial boiling point”) under the particular conditions in the fuel introduction tube.

Fuel introduction tubes are inexpensive, industry standard products. Fuel introduction tubes, unlike hydraulic nozzles or injectors, introduce the fuel in a narrow and focused pattern, or jet, preferably substantially axially in or towards the center of the oxygen-containing gas stream. This reduces the migration of fuel to the pipe wall, reducing the wall wetting effect and the formation of carbon.

Embodiments of the present apparatus and method are particularly suitable for fuel processors that are used in engine system applications where a liquid fuel stream is to be introduced into an oxidant stream comprising hot engine exhaust gas, for downstream conversion into a hydrogen-containing gas stream. Here the temperature of the oxidant stream often exceeds the boiling point of the liquid fuel (typically diesel or gasoline). Boiling of the fuel in the tube is more of an issue in this particular application than in other applications (such as fuel burners), because the quantity of liquid fuel being introduced into the hot gas stream is typically much lower. In the absence of adequate thermal shielding, heat from the hot oxidant stream and fuel processor can transfer to the fuel introduction tube causing the liquid fuel to boil, which can create gas bubble blockages and prevent the steady flow of liquid fuel through the tube.

The fuel introduction tube generally allows for a continuous fuel flow, with desirable (relatively low) mass flow rates that suit engine system applications, reduced fuel supply pressure requirements, and reduced introduction speeds so that the fuel can be introduced at a slower speed than the speed of the oxidant stream. The atomization, vaporization and mixing of the fuel with the oxidant stream can be aided by additional devices within the fuel processor downstream of the introduction tube but upstream of the reforming zone, examples of which are described below. The introduction of the fuel into the oxidant stream, as described herein, facilitates downstream atomization, vaporization and mixing of the fuel with the oxidant stream.

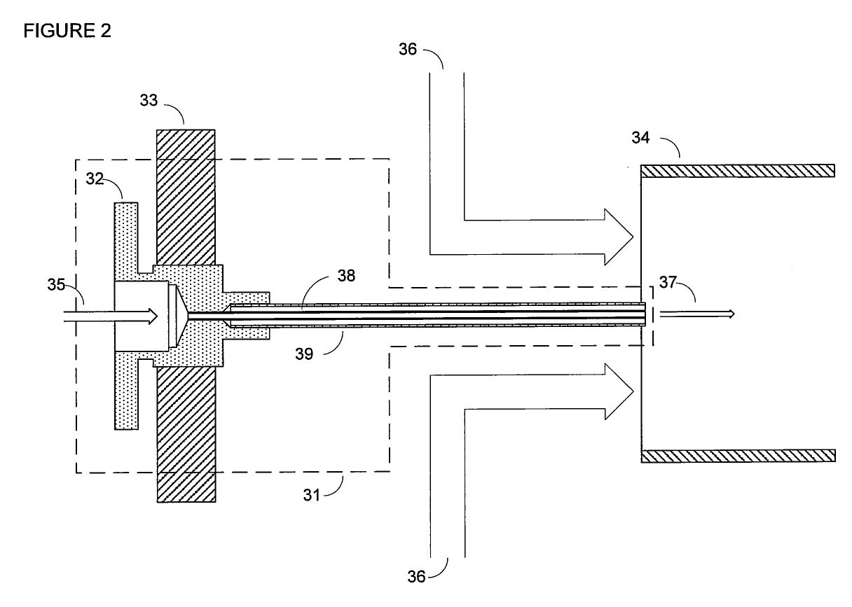

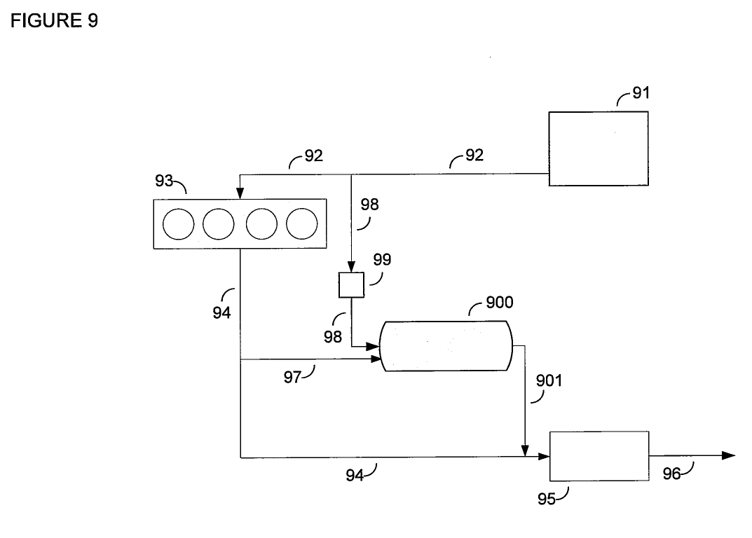

In FIG. 2, an embodiment of a passively thermally shielded (or insulated) introduction tube assembly 31, comprises an introduction body 32, which attaches and locates introduction tube 38 and outer sleeve 39, forming an annular gap between introduction tube 38, and outer sleeve 39. In the illustrated embodiment, the annular gap at the distal end of introduction tube 38 and outer sleeve 39 from introduction body 32 is open. Introduction body 32 is attached to an external wall of fuel processor 33. Introduction tube assembly 31 is used to introduce a liquid fuel, such as diesel or gasoline, substantially axially into oxidant stream 36. Mixing tube 34, located at the inlet of or inside the fuel processor 33, directs the fuel jet 37 and oxidant stream 36, to further downstream processes, not shown in FIG. 2. Fuel inlet stream 35, is supplied via a fuel supply sub-system that can be similar to that described below in reference to FIG. 9. Oxidant stream 36 is supplied by an oxidant reactant supply sub-system that can be similar to that described below in reference to FIG. 9.

In FIG. 2, fuel inlet stream 35, flows through introduction tube 38, via introduction body 32, and is introduced into the center portion of mixing tube 34. The end of the introduction tube 38, is substantially planar in the radial direction (that is, squared-off) and terminates at or near the inlet of mixing tube 34. In other embodiments, the end of the introduction tube can be angled, tapered, cylindrical and/or another convenient shape instead of being squared off. Mixing tube 34 can comprise features that promote fuel atomization, fuel vaporization and mixing of the oxidant stream with fuel. These features are not shown in FIG. 2. Fuel jet 37, exits introduction tube 38, in a narrow and focused pattern or jet. Fuel jet 37 is introduced into oxidant stream 36 at or near the entrance to mixing tube 34. In engine system applications and some other applications, oxidant stream 36 can reach temperatures exceeding 600° C. The narrow spray pattern of the jet reduces the amount of fuel that comes in contact with the interior walls of mixing tube 34, reducing wall wetting. It is desirable to maintain the temperature of the liquid fuel stream traveling through introduction tube 38, below its boiling point. Without adequate thermal shielding, heat from the fuel processor and the oxidant stream can otherwise cause the liquid fuel stream to boil, which can create a disruption to the flow of fuel and the formation of carbon and residues. The contact area between introduction body 32 and introduction tube 38 is preferably kept small in order to reduce the conductive thermal path from fuel processor 33, via introduction body 32 and introduction tube 38, to the fuel stream flowing in tube 38. In the embodiment illustrated in FIG. 2, thermal shielding of the introduction tube is achieved by locating introduction tube 38 co-axially inside a larger outer sleeve 39. The annular gap between outer sleeve 39 and introduction tube 38 reduces the convective heat transfer from oxidant stream 36, to the liquid fuel stream flowing in introduction tube 38. In this embodiment, introduction tube assembly 31, is passively thermally shielded which offers the advantage of reducing or eliminating the requirement for a shielding fluid supply sub-system

In engine systems incorporating a fuel processor for the production of hydrogen or syngas, it is believed to be advantageous if the liquid fuel is introduced into the oxidant stream at a lower speed than the oxidant stream speed. The speed differential and the resulting acceleration of the fuel stream can assist the atomization process downstream of the fuel introduction tube.

The dimensions of the introduction tube (for example, inside and outside diameter) will depend upon the size and desired output of the fuel processor. In one embodiment, the introduction tube can be constructed from stainless steel alloy, with an inside diameter of 0.69 mm (0.027 in) and an outside diameter of 1.07 mm (0.042 in). The outer sleeve can be constructed from stainless steel alloy, with an inside diameter of 2.68 mm (0.106 in) and an outside diameter of 3.18 mm (0.125 in). The interior wall surfaces of the introduction tube can be polished or coated to reduce the formation of fuel by-product gums, residues or carbon on the wall.

The pressure drop across the introduction tube is low, for example, less than 690 kpag (100 psig) and preferably less than about 69 kpag (10 psig). The fuel inlet stream is preferably at pressures up to about 690 kpag (100 psig). The introduction tube creates a low speed liquid fuel jet, preferably up to about 10 m/s (32.8 ft/s), with a narrow jet diameter. The narrow jet of fuel reduces the probability of creating a locally flammable or combustible mixture, reducing the probability of a flashback from occurring. The introduction tube could be a needle and is a low cost alternative to state of the art nozzles. Other nozzles generally require high fuel pressure in order to adequately atomize the fuel. The turndown ratio with such nozzles is limited because if the fuel pressure is reduced then poor atomization occurs. In the present approach, which typically uses a low fuel pressure, the turndown ratio is extremely large (even infinite). The primary function of the introduction tube is merely to introduce a liquid fuel into the hot oxidant stream. In the present approach, the atomization process does not depend in a significant way on the pressure or quantity of the fuel introduced. The oxidant stream is accelerated and shears the low speed fuel jet creating fine droplets. A low pressure fuel pump can be utilized, or the system can operate without a fuel pump and rely on the venturi effect created by the oxidant stream flowing around the introduction tube to draw the fuel into the oxidant stream. Small fuel quantities can be introduced and efficient atomization achieved using a continuous or intermittent flow.

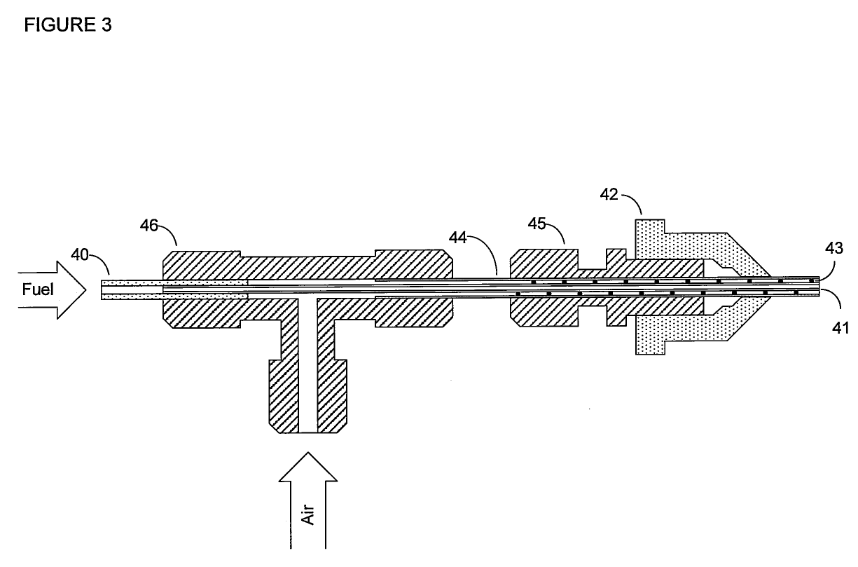

In other embodiments, the introduction tube is actively thermally shielded, for example, it can be shielded with a stream of air or other fluid. Shielding of the fuel introduction tube can be achieved, for example, by surrounding the tube co-axially with a larger outer sleeve and directing a shielding fluid (such as water or air) to flow between the tube and the outer sleeve. The outer sleeve can also provide structural support to the inner tube, reducing the possibility of it deforming. A detailed view of an embodiment of an air-shielded introduction tube is shown in FIG. 3. In FIG. 3, introduction tube connector 40 is attached to introduction tube 41. Wire 43, is coiled around introduction tube 41, which creates a gap and air flow channel between introduction tube 41, and outer sleeve 44. Outer sleeve 44 is attached and sealed to male connector 45. Male connector 45 is attached to body 42. Body 42, is attached to the fuel processor housing or outer shell (not shown in FIG. 3). T-fitting 46, is attached and sealed to outer tube 44, and introduction tube connector 40. Liquid fuel is supplied to and flows through introduction tube connector 40, and through introduction tube 41, exiting into the fuel processor (not shown in FIG. 3). While the fuel processor is operational, a flow of air is supplied to and flows through T-fitting 46, proceeding through the air flow channel between introduction tube 41 and outer sleeve 44, and exiting, for example, into the fuel processor (not shown in FIG. 3). The temperature of the air is substantially below the boiling point of the liquid fuel so that the flow of air in the channel between the introduction tube 41, and the outer sleeve 44, thermally shields introduction tube 41 from heat radiating from the fuel processor via body 42, and male connector 45.

The introduction tube can be actively thermally shielded using other fluids besides air or water, or it can be actively shielded or cooled by other methods involving convection or conduction. The introduction tube can be thermally shielded from the reactor body by incorporating a shielding fluid at the reactor itself or at the body of the introduction tube, or both.

The introduction tube can optionally function as a spark electrode or spark plug, forming part of an integrated ignition source for the fuel and engine exhaust stream mixture. The introduction tube can be electrically insulated from the fuel processor, and connected to a high voltage source. As the high voltage is supplied, a spark can be created between the introduction tube and the wall of the mixing tube. This can ignite the fuel and oxidant stream inside the mixing tube to initiate the combustion processes.

In normal operation of preferred embodiments of the fuel processor, it is only the liquid fuel stream that passes through the fuel introduction tube. Gaseous reactants, such as the oxidant stream, are introduced into the fuel processor via other devices. However, in some situations it can be desirable to be able to flush or purge liquid fuel from the introduction tube using a gas stream (such as air), for example, when the system is shut down. This can prevent the formation of carbon or deposit blockages inside the introduction tube.

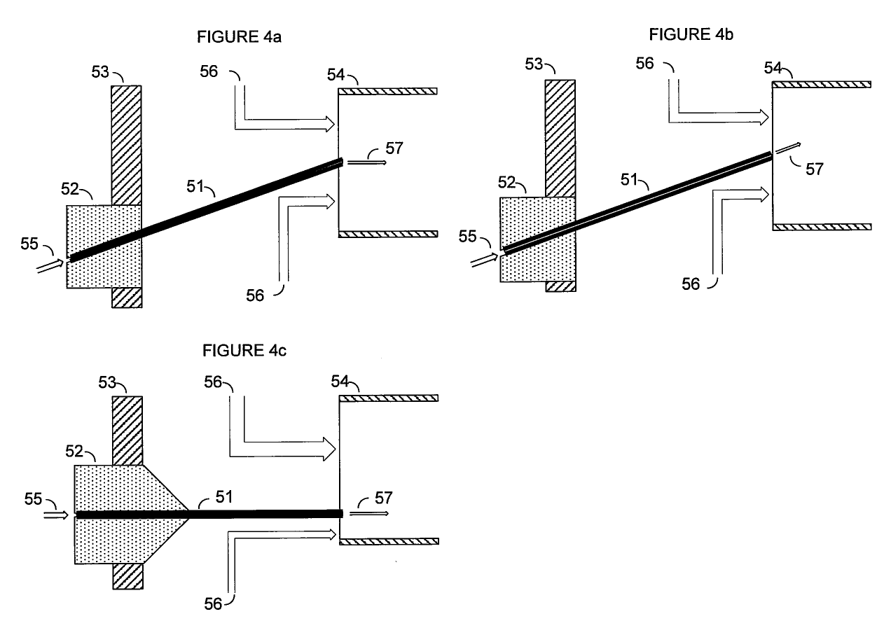

In some fuel processor embodiments, the introduction tube can be disposed at an angle to the mixing tube, as shown in FIG. 4a; the introduction tube can introduce the fuel stream at an angle to the mixing tube, as shown in FIG. 4b; the introduction tube can be located off-center to the mixing tube, as shown in FIG. 4c.

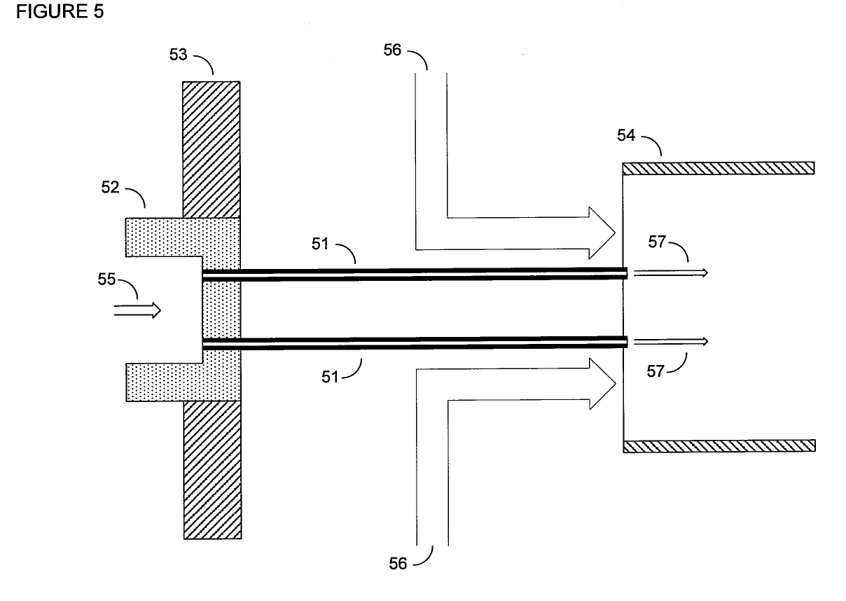

In other fuel processor embodiments multiple fuel introduction tubes can be used. For example, multiple tubes could give better flow distribution, or it can be advantageous to be able to adjust the number of tubes that are used (active) depending on the output requirements from the fuel processor. Multiple introduction tubes can be configured as shown in FIG. 5.

In FIGS. 4a, 4b, 4c and 5, a simple cylindrical introduction tube 51, is supported and attached to introduction body 52. Introduction body 52 is attached to an external wall of fuel processor 53. Mixing tube 54, located within the fuel processor, directs the diesel fuel jet 57 and oxidant stream 56, to further downstream processes, not shown in FIGS. 4 and 5. Fuel inlet stream 55 is supplied through a fuel supply sub-system that can be similar to that described in below in reference to FIG. 9. Oxidant stream 56 is supplied by an oxidant supply sub-system that can be similar to that described in below in reference to FIG. 9.

Introduction tubes for the introduction of liquid fuel into a hot oxidant stream, such as an engine exhaust stream, for subsequent fuel processing can be used in vehicular and non-vehicular systems. They are, however, particularly applicable in vehicular systems in which the on-board fuel processor is compact. Because of the physical constraints in such systems it is more important to control and restrict the spray pattern of the liquid fuel as it enters the fuel processor.

### Embodiments Comprising a Critical Flow Venturi

Critical flow venturis (also known as sonic nozzles, critical flow nozzles, sonic chokes, and converging-diverging nozzles) have a convergent section (inlet) upstream of the throat (the point or region of minimum flow area) and typically a divergent section on the other side of the throat. Thus, as the fluid stream moves through a CFV (in the principal flow direction) it sequentially traverses a convergent zone, a throat and a divergent zone. A CFV can accelerate the fluid flow to sonic speed at the throat, when the pressure at the throat relative to the inlet pressure is reduced to or below a critical value. For example, the critical throat-to-inlet pressure is 0.528 for air. When the fluid reaches sonic speed or the critical velocity, the mass flow rate of fluid flowing through the CFV is at the maximum possible value for the upstream conditions, and the CFV is said to be operating at a choked, critical, or sonic condition. Under choked conditions, mass flow through the CFV is not affected by changes in the flow downstream, and remains substantially constant even if the downstream pressure changes.

A divergent section is commonly used downstream of the throat so that after the fluid passes through the throat of the CFV its speed decreases and the pressure increases, thereby providing some pressure recovery across the device.

The mass flow rate through the CFV is affected by the inlet fluid composition, pressure and inlet temperature, and also depends on the convergent profile, throat diameter and surface finish of the CFV. A CFV typically requires a surface roughness of about <1.6 micron (1.6 μm or 6.3×10⁻⁵ in), while conventional venturis typically can tolerate a rougher surface finish for most applications. When choked, the mass flow through the CFV is proportional to the inlet pressure and inversely proportional to the square root of absolute temperature for a given fluid composition.

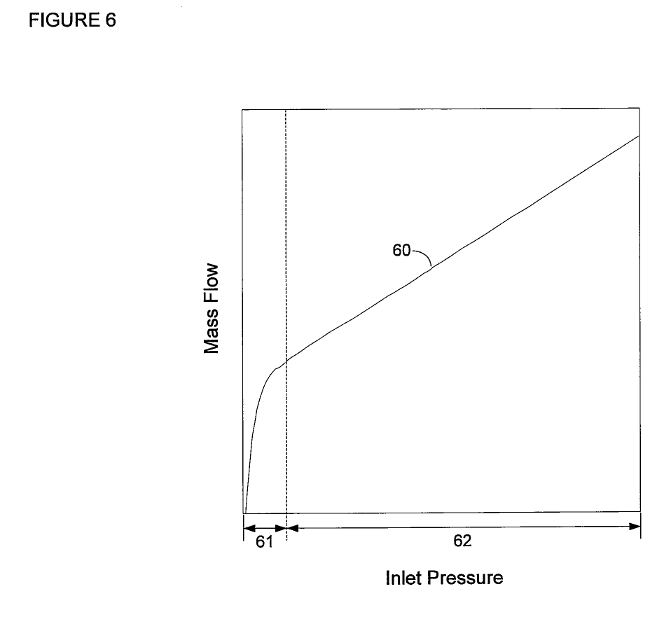

In FIG. 6, line 60 is a plot illustrating the relationship between the mass flow and inlet pressure of a venturi. Typically, a conventional venturi operates in regime 61, while a venturi operating as a CFV operates in regime 62.

The present fuel processor and operating method rely on properties that are particular to a CFV rather than a conventional venturi. In the present approach, preferably during a predominant portion of the operating duration of the CFV in the fuel processor, the fluid flow through the CFV is choked. This is illustrated in FIG. 6, as line 60, in regime 62. The venturi can operate in both regime 61 and regime 62, but preferably operates as a CFV as in regime 62 for some, or preferably most, of the time. Typically, conventional venturis operate with smaller pressure drops between inlet and outlet of the venturi, while the mass flow is proportional to the square root of the pressure drop, as illustrated in FIG. 6, as line 60 in regime 61. Hence the mass flow through a conventional venturi is affected more dramatically by changes in the upstream pressure. The throat velocity of the CFV can be as high as 700 m/s (2,297 ft/s), while a conventional venturi usually operates at a throat velocity less than 250 m/s (820 ft/s).

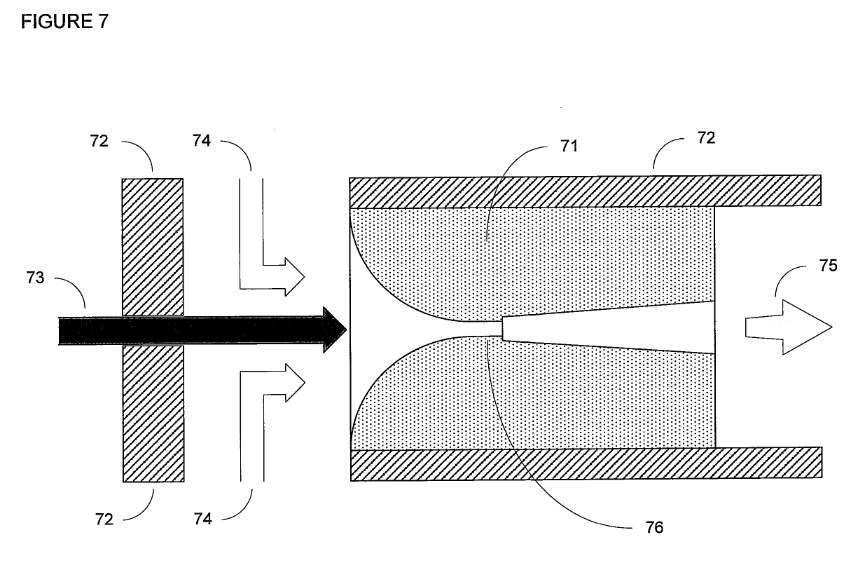

FIG. 7 shows a CFV incorporated in the inlet region of a fuel processor. In FIG. 7, CFV 71 is attached to fuel processor body 72 (although in some embodiments the CFV could be located external to the outer shell or main housing of the fuel processor). Fuel 73 is supplied via a fuel inlet line (not shown in FIG. 7) and introduced into oxidant stream 74 upstream of CFV 71. Oxidant stream 74 is directed to CFV 71 via an oxidant inlet line (not shown in FIG. 7). The mixture of fuel 73 and oxidant stream 74 flows through CFV 71 and reaches sonic or near sonic speed, so that the CFV is choked. If fuel 73 is a liquid, the acceleration to sonic or near sonic speed will shear the liquid fuel, reducing the droplet size of the fuel while increasing its surface area. The increase in surface area increases the heat transfer rate and reduces the vaporization time. Thus, a liquid fuel can be atomized and vaporized as it passes through the throat 76 of CFV 71. Turbulent flow through the throat 76 of CFV 71 aids in mixing the fuel 73 and oxidant stream 74 to create combined reactant stream 75. Combined reactant stream 75 exits CFV 71 and proceeds downstream within the fuel processor to the combustion zone where oxidation reactions occur, and then on to the reforming process where further conversion to a hydrogen-containing gas stream occurs.

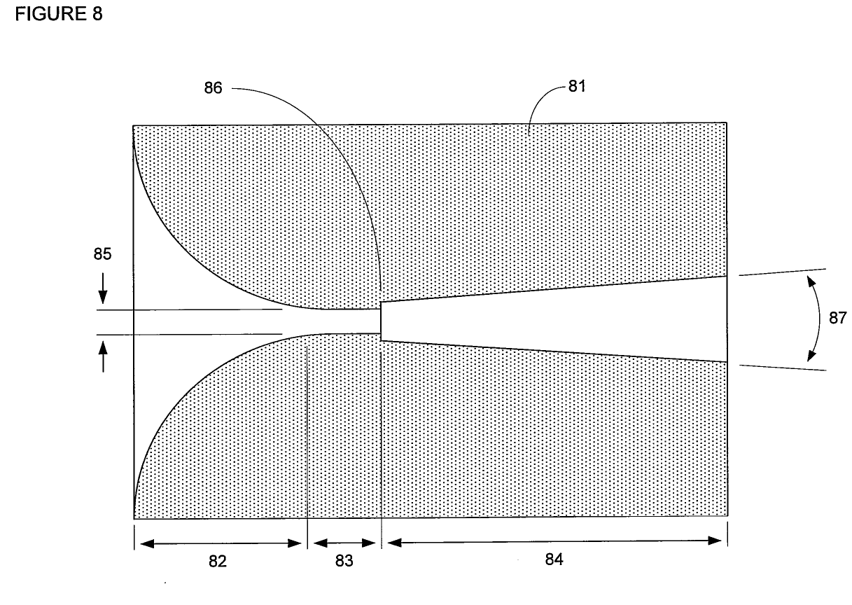

In FIG. 8 a cross-sectional profile of an embodiment of a CFV 81 is shown schematically. At the inlet of CFV 81, convergent inlet section 82 reduces to throat 83. This reduction in cross-sectional area along convergent inlet section 82 causes pressure of the fluid mixture to drop, while the speed increases. The throat diameter 85 is sized to create a choked condition at the desired maximum mass flow rate. As the fluid mixture reaches sonic speed, the maximum flow rate across CFV 81 is reached. As the fluid mixture passes the through throat 83 it flows into the divergent section 84 where the speed of the mixture decreases and the pressure increases. The divergent angle 87 affects the pressure recovery through CFV 81. The divergent angle or total cone angle, is typically less than 16°, and for certain preferred embodiments the preferred divergent angle has been found to be about 10° (that is about 5° on either side of the central longitudinal axis). The profile of the divergent zone can be straight (conical, as shown), or curved (trumpet-like). The divergent section can be part of the CFV (as shown in FIG. 8) or can be a separate component connected to the CFV, such as a mixing tube, in which case the CFV will comprise just a convergent inlet section and a throat.

CFV 81 illustrated in FIG. 8 has a step 86 in its profile just downstream of throat 83. This step 86 assists in stabilizing the location of the shock wave created by the sonic fluid speeds, thereby stabilizing the flow characteristic of the CFV. The step can be incorporated into a converging-divergent CFV, or can be located at the interface between the CFV and another immediately downstream component such as a mixing tube. The latter approach can simplify the manufacturing process and cost, as the step can act as the interface between two separate less expensive components of the fuel processor. In other embodiments, the step in the venturi profile between the venturi throat and divergent section can be eliminated, or there can be one or more steps in the throat or divergent section.

### Engine System Embodiment

FIG. 9 illustrates schematically an embodiment of an engine system with a fuel processor and an exhaust after-treatment system. In this illustrated embodiment the fuel processor is a syngas generator (SGG). In FIG. 9, fuel tank 91 supplies liquid fuel, through fuel supply line 92, to internal combustion engine 93. An optional fuel filter, fuel pump, fuel pressure regulating device and fuel flow control device (all not shown in FIG. 9) can be integrated into fuel tank 91 or into fuel supply line 92. An optional fuel return line can return fuel back to fuel tank 91. Internal combustion engine 93 could be a diesel, gasoline, liquefied petroleum gas (LPG), methanol, ethanol, or similarly fueled engine of, for example, compression ignition or spark ignition type. The engine can be part of a vehicular or non-vehicular system. The internal combustion engine will comprise an air supply subsystem (not shown in FIG. 9).

Engine exhaust line 94 directs at least a portion of the engine exhaust stream to exhaust after-treatment device 95. Engine exhaust line 94 can incorporate other emissions reduction devices such as exhaust gas recirculation (EGR) systems (not shown in FIG. 9). Engine exhaust line 94 can contain a turbo-compressor and/or intercooler (not shown in FIG. 9). Exhaust after-treatment device 95 can comprise various exhaust after-treatment components such as Lean NOx Traps (LNTs), Diesel Particulate Filters (DPFs), Diesel Oxidation Catalysts (DOCs), and a noise muffler and associated valves, sensors and controllers. The treated engine exhaust gas stream flows through exhaust pipe 96, and exits into the surrounding atmosphere.

A portion of the engine exhaust stream from line 94 is directed to SGG 900 via SGG oxidant inlet line 97. Optionally, air from an air supply sub-system (not shown in FIG. 9) can also be introduced into SGG 900, via oxidant inlet line 97 and/or via one or more other inlets, at some points or continuously during operation of SGG 900. Fuel from fuel tank 91 is supplied from fuel supply line 92 to SGG 900 via SGG fuel inlet line 98. An optional fuel filter, fuel pump, fuel pressure regulating device and/or fuel heat exchanger (all not shown in FIG. 9) can be integrated into SGG fuel inlet line 98. Optionally, a fuel pre-heater can also be incorporated into the system. A fuel metering assembly 99 in line 98 controls the mass flow and pressure of the fuel supplied to SGG 900. The oxidant stream is metered internally in SGG 900 using a CFV as described below.

SGG 900 converts the fuel and the oxidant stream, comprising engine exhaust, into a syngas stream. At least a portion of the syngas stream produced is supplied via syngas outlet line 901 to exhaust after-treatment device 95. Syngas outlet line 901 can contain optional valves, sensors, controllers or similar equipment. The syngas stream is used to regenerate, desulfate or to heat exhaust after-treatment device 95, and can be directed to other hydrogen consuming devices within the system, such as fuel cells (not shown) and/or to the engine itself.

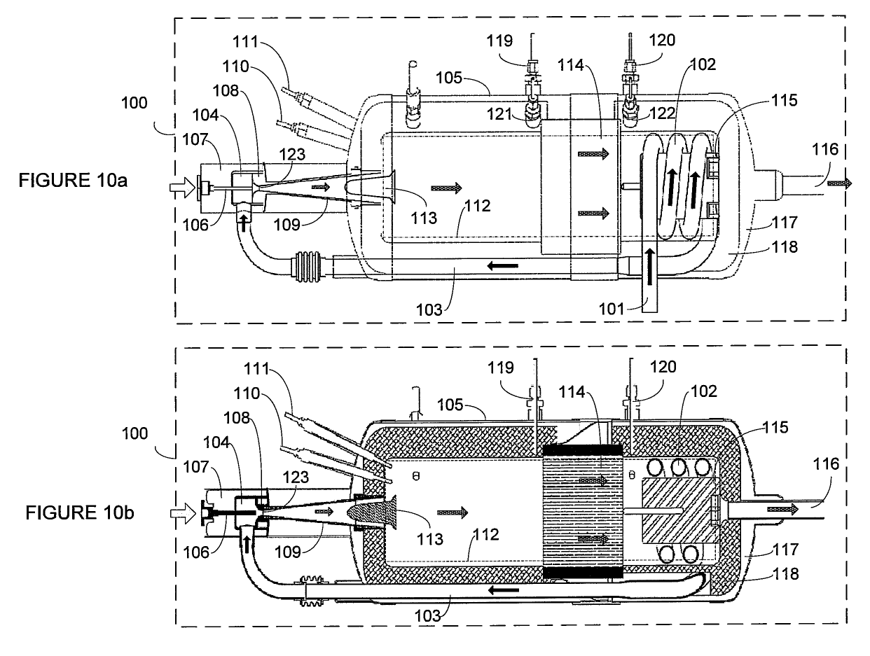

SGG 900 can incorporate a fuel introduction tube, CFV, heat exchanger and other components (not shown in FIG. 9) as described in more detail below in reference to FIGS. 10a and 10b. The CFV can be sized to meet the SGG output requirements. A CFV offers particular advantages as a device for passive control of reactant flow in situations where there are significant variations in the upstream pressure and temperature. It provides high predictability and repeatability of the flow despite the upstream variations, and there are no moving parts in the device. The engine exhaust stream temperature, pressure, mass flow, composition and emission levels will vary significantly over the operating range of the engine. The CFV will be affected by the pressure and temperature of the engine exhaust stream upstream, but the CFV passively meters the flow and reduces the effect of these fluctuations. Because of its regulating effect, the CFV provides low turndown—in other words, even as the engine moves from idle to full power, the CFV passively meters the mass flow of engine exhaust stream to the SGG, reducing the turndown of the SGG (so that the output from the SGG does not change significantly with changes in the engine operation). The CFV can therefore replace the requirement for a complex and costly mass flow metering system and its associated devices. The O/C ratio within the SGG can be altered by adjusting the mass flow rate of the fuel stream into the SGG. Even if the fuel is introduced upstream of the CFV throat, adjustments to the mass flow rate of the fuel do not significantly affect the metering of the engine exhaust or oxidant stream by the CFV.

The CFV could be designed and sized to meter and/or mix below sonic speeds. In many cases the CFV will not operate at a critical condition over the entire operating range of the system. For example, the CFV could operate below critical (sonic) speed at engine idle.

The exhaust pressure created by the engine is limited, and increases to the engine exhaust backpressure can affect the performance, efficiency and fuel consumption of the engine. Another advantage of the CFV is the ability to recover some of the pressure that is lost as the reactant stream passes through the throat of the CFV. The pressure recovery can reduce the overall pressure drop across the CFV and SGG.

During certain SGG operating conditions, the combined reactant stream is combustible and within the auto-ignition temperature range. Under choked conditions the CFV creates a sonic or near sonic speed at the throat, which acts as a flashback arresting feature. The high speed created by the CFV is greater than the flame speed of the combined reactant stream, which can prevent a flashback from propagating back through the CFV, thereby reducing or eliminating the need for an additional flashback arresting device.

### Embodiments Comprising a Heat Exchanger and Other Components

FIGS. 10a and 10b illustrate an embodiment of a fuel processor incorporating a fuel introduction tube and a critical flow venturi (CFV) which are discussed above, along with other components which are described in more detail below, including a heat exchanger, a mixing tube, a bluff body, glow plugs, and a carbon particulate filter. The way these components interrelate physically and function together during operation of the fuel processor is described.

FIG. 10a shows a transparent view while FIG. 10b shows a cross-sectional view of a non-catalytic syngas generator (SGG) 100. In preferred embodiments, an oxidant stream enters SGG 100 via oxidant inlet conduit 101 which is joined to outer shell 105. The oxidant stream is an oxygen-containing gas stream that typically also contains some moisture. In certain embodiments it is an exhaust gas stream from a combustion engine, with or without additional air added. The oxidant stream flows through oxidant inlet conduit 101 and into a heat exchanger 102 which comprises a coiled tube located in reaction chamber 112. Reaction chamber 112 is a cavity formed by insulation 118 and comprises a “combustion zone” where oxidation processes occur and a downstream “reforming zone” where reforming processes occur. The location of heat exchanger 102 allows for the transfer of heat from a hot gas mixture (e.g. a product syngas stream) within reaction chamber 112 to pre-heat the incoming oxidant stream. Heat exchanger 102 is preferably located at or near the maximum temperature zone in reaction chamber 112, or alternatively at or near outlet conduit 116. This offers the advantage of recovering at least a portion of the sensible heat from the hot gas mixture close to or downstream from where the reforming reactions are occurring. The coiled tube configuration of heat exchanger 102 allows for thermal expansion and contraction of the heat exchanger, low pressure drop, high surface area and reduced volume. Heat exchanger 102 is preferably configured such that the oxidant stream flows inside the coiled tube in a co-flow direction relative to the flow of the product syngas stream in reaction chamber 112, towards outlet conduit 116. This reduces the variation in the temperature range of the oxidant stream as it exits heat exchanger 102 during normal operation of SGG 100. In alternative embodiments heat exchanger 102 can comprise one or more concentric sleeves where the oxidant stream flows on one side of the sleeve while the hot gas mixture flows on the other side of the sleeve. The oxidant stream is pre-heated upstream of an oxidant mixing and metering device, which in the illustrated embodiment is CFV 108. In applications where the temperature of the oxidant stream supplied to the SGG can vary greatly, such as when it comprises exhaust gas from a combustion engine, pre-heating offers the advantage of reducing the variation in the temperature of the oxidant stream prior to its introduction into CFV 108. In addition to providing some self-regulation of the operating temperature of SGG 100 as described below, an additional advantage of using the heat exchanger is that it can increase the efficiency of the SGG as less fuel is consumed for the endothermic reforming reactions.

The oxidant stream flows through heat exchanger 102, and via conduit 103 into oxidant chamber 104. Alternatively, at least a portion of the oxidant stream can bypass heat exchanger 102 and flow into oxidant chamber 104 through an optional bypass conduit (not shown in FIG. 10a or 10b). A large portion of conduit 103 is located within shell 105 and is thermally insulated by a ceramic mat 117 in order to reduce heat loss from the oxidant stream as it travels from heat exchanger 102 to oxidant chamber 104.

A fuel stream is supplied to SGG 100 through a fuel introduction tube 106, as described in more detail above. In preferred embodiments the fuel stream comprises diesel, supplied at a pressure of up to about 100 psig (690 kPag), and is actively metered in order to control parameters such as, for example, the equivalence ratio and/or oxygen-to-carbon (O/C) ratio of the reactant mixture supplied to SGG 100. By adjusting the oxygen-to-carbon ratio (O/C) the SGG can be operated in a so-called “fuel rich mode” or a “fuel lean mode” or stoichiometrically. When the SGG is operating stoichiometrically both reactants are essentially entirely consumed in combustion processes. If excess fuel is supplied (lower O/C ratio) then the SGG will be operating in a fuel rich mode, with essentially all of the oxidant being consumed. Similarly if a reduced amount of fuel is supplied (higher O/C ratio) then the SGG will be operating in a fuel lean mode, with essentially all of the fuel being consumed by combustion. In the illustrated embodiment, an external fuel metering apparatus is employed to meter the fuel stream, and is separate from SGG 100. The low supply pressure requirement of the fuel stream allows SGG 100 to be supplied with fuel from a combustion engine fuel supply sub-system in applications where the SGG is used with a combustion engine. Alternatively inexpensive low pressure fuel pumps can be used. Fuel introduction tube 106 is thermally shielded with thermal insulation 107 and located at a distance from the reaction chamber 112 in order to maintain the temperature of fuel introduction tube 106 below the boiling temperature of the liquid fuel stream during normal operation of SGG 100.

The fuel stream then exits fuel introduction tube 106 in a narrow or focused pattern or jet, into oxidant chamber 104 and combines with the oxidant stream to flow into CFV 108. The oxidant stream rapidly accelerates the liquid fuel stream to sonic or near sonic speeds as the fuel and oxidant streams (the “combined reactant stream”) flow through the throat of CFV 108. The shearing of the fuel stream as it is introduced into the oxidant stream, combined with the turbulent flow and associated shock waves as the fuel and oxidant travel through the throat of CFV 108 and mixing tube 109, assists in atomizing, vaporizing and mixing the fuel stream with the oxidant stream. This reduces the tendency for localized fuel rich conditions and resultant carbon formation. Instead of being introduced close to, but upstream of CFV 108 as shown in FIGS. 10a and 10b, the fuel could be introduced at or just downstream of the throat of the CFV. The speed and turbulent flow associated with the shock wave in the mixing zone will still generally provide satisfactory mixing of the reactant streams. This approach differs from the conventional approach of injecting a fuel stream in a spray pattern into an oxidant stream, in order to atomize and mix the fuel with oxidant stream.

As it passes through CFV 108, the combined reactant stream is preferably at a speed which exceeds the flame speed in the combined reactant stream during normal operation of SGG 100, creating a flashback arresting feature. CFV 108 also functions to passively meter the mass flow of the oxidant stream into SGG 100, reducing or eliminating the need for additional oxidant stream flow control devices. This passive metering effect relies on properties that are particular to a CFV rather than a conventional venturi, as described above.

For gaseous fluids, as the temperature of the gas stream entering a CFV increases, the gas density decreases despite an increase in the sonic speed of the gas stream. The reduction in gas density has a greater effect on the mass flow rate than the increase in sonic speed. As a result, the mass flow rate of the gas stream through the CFV decreases as the temperature of a gas stream entering a CFV increases. This has a self-regulating effect on the operating temperature of SGG 100 during normal operation. Thus, as the temperature of reaction chamber 112 or SGG 100 increases, heat exchanger 102 transfers additional heat to the incoming oxidant stream increasing its temperature, which reduces the allowable mass flow of oxidant through CFV 108 and decreases the O/C ratio. Decreasing the ratio of oxidant-to-fuel causes the temperature of SGG 100 to decrease during normal operation of SGG 100. As the temperature of the incoming oxidant stream then decreases, the reverse effect occurs: oxidant flow through CFV 108 increases and the O/C ratio increases which then causes the temperature of SGG 100 to increase during normal operation of SGG 100 The heat exchanger which transfers heat from the reaction process to the oxidant stream upstream of CFV, provides a passive self-regulating effect on the temperature inside the SGG. Thus, the use of a heat exchanger in combination with a CFV in this way assists in regulating the temperature of the reaction process.

An optional combination of water, steam, oxygen, air, carbon monoxide and/or heat could be added upstream of the CFV. The CFV can be provided with small openings in the throat of the CFV, which allows introduction of other gases or liquids for modification of the gas composition. The fluid being introduced can be pressurized or drawn, based on the CFV acting like an ejector.

More than one CFV could be used to meter, mix or arrest flashback in a fuel processor. For example, each of several CFVs could have associated valves to adjust the number that are operational for different output levels, or CFVs with different flow characteristics could be used to give the desired mass flow behavior with varying inlet conditions, or in large fuel processors multiple CFVs could be used in parallel to give better coverage.

The combined reactant stream flows through CFV 108 into mixing tube 109. At the interface between CFV 108 and mixing tube 109, there can be a step discontinuity 123 between the throat of CFV 108 and the divergent section of mixing tube 109, as described in reference to FIG. 8 above. In the illustrated embodiment, mixing tube 109 provides a chamber which houses the sonic shock wave. As the combined reactant stream flows through mixing tube 109, the entrained fuel is subjected to a large pressure gradient and the bulk force of the sonic shock wave which further assists in atomization, vaporization and mixing of the fuel and oxidant in the combined reactant stream. In addition, mixing tube 109 assists in the vaporization and mixing of the combined reactant stream by prolonging the mixing duration prior to introduction into and exposure to the high temperature of reaction chamber 112. The sensible heat required to vaporize the liquid fuel is at least partially provided by pre-heating the oxidant stream in heat exchanger 102. In some embodiments, mixing tube 109 can be actively or passively thermally shielded from the reaction chamber and/or SGG in order to maintain the temperature of the combined reactant stream traveling through mixing tube 109 within a desired range. If the mixing tube 109 is passively thermally shielded an insulating material such as ceramic mat can be employed. Alternatively, the mixing tube can comprise a larger outer sleeve, located on the same longitudinal axis as the mixing tube, creating an annular gap between the outer sleeve and mixing tube. The annular gap can create a stagnant zone providing a thermal shield. In another variation, a thermal fluid can be employed to flow around the exterior of the mixing tube to actively cool and thermally shield the mixing tube. The fluid may or may not be contained by an outer sleeve. Maintaining the mixing tube below a desired temperature can also permit the use of standard (non-specialty) materials. The divergent section of CFV 108 and/or mixing tube 109 enables at least partial pressure recovery, which reduces the overall pressure drop across SGG 100. Mixing tube 109 protrudes from shell 105 in order to reduce the volume of SGG 100, although in some embodiments it could be located within the shell. Mixing tube 109 is also located upstream of and external to reaction chamber 112 in order to limit the temperature of the combined reactant stream within the mixing tube for the reasons described above. Vaporization of the fuel and mixing the fuel and oxidant streams prior to introduction into the reaction chamber differs from the conventional approach of injecting fuel directly into a chamber where the reaction process occurs and the temperatures are extreme.

A bluff body is a non-streamlined body that produces a large drag force in a flowing fluid stream and a region where considerable reflux happens. In the illustrated embodiment, a bluff body 113 is located near the exit of mixing tube 109 and is employed to improve the flow distribution of the combined reactant stream in reaction chamber 112, and to create a gas reflux zone. The reflux zone is believed to create one or more beneficial effects including: directing a portion of the hot gases from the surrounding area into the fresh reactant stream thereby assisting in the ignition of a portion of the fresh combined reactant stream within the reflux zone; reducing the local bulk gas speed (below the flame speed of the local combined reactant stream); increasing the residence time of a portion of the fresh combined reactant stream; and creating a local high-temperature zone that serves as a source of flame propagation. In addition, the gas reflux zone assists in stabilizing the location of the flame of the reaction process, thereby reducing the required length of reaction chamber 112 and the volume of SGG 100. Better distribution of the combined reactant stream within reaction chamber 112 increases the effectiveness of reaction chamber 112, and in turn reduces the volume of SGG 100. Bluff body 113 offers additional advantages, for example, increasing the speed of the combined reactant stream at or near the exit of mixing tube 109, blocking some of the radiant heat energy traveling from the combustion zone back into mixing tube 109 (mitigating the risk of flashback of the flame in the mixing tube) and increasing the turndown ratio or operating range of SGG 100.

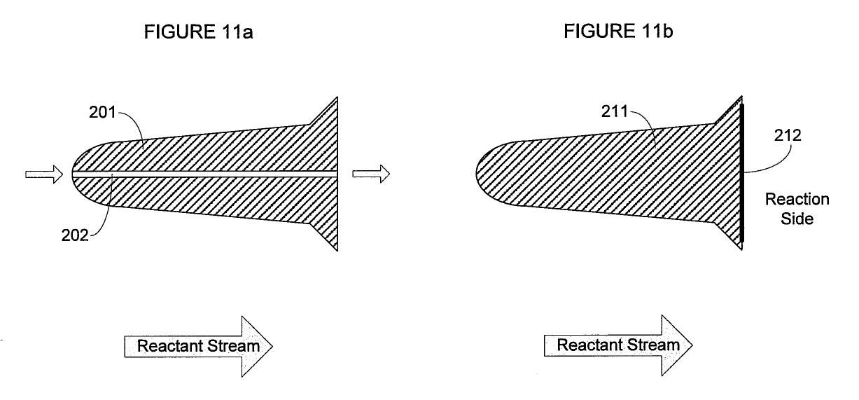

FIGS. 11a and 11b illustrate examples of embodiments of bluff bodies. A suitable bluff body can comprise one or a combination of the illustrated features. The bluff body can be of various shapes and sizes, and can be constructed from various structures, for example, solid or perforated materials, foams, fibrous materials, sintered materials, and can be constructed from suitable ceramic or metal materials. In FIG. 11a, body 201 incorporates a pilot hole 202 that allows a portion of the combined reactant stream to flow through the body. In FIG. 11b body 211 incorporates a catalyst layer 212 on the reaction side of the body. This can be an oxidation catalyst layer comprising a platinum group metal or alloy in order to promote combustion and assist in locating and stabilizing the flame within the reaction chamber, reducing the possibility of the flame from propagating back into the mixing tube. The catalyst can be incorporated on any appropriate surface so that it stabilizes the flame without causing flashback in the mixing tube.

In FIGS. 10a and 10b, mixing tube 109 interfaces with insulation 118 which forms and thermally insulates reaction chamber 112. As the combined reactant stream exits mixing tube 109 and flows into reaction chamber 112 the transition geometry is abrupt, for example, the angle between the inner wall at the exit of mixing tube 109 and the adjacent wall of insulation 118 or reaction chamber 112 can be about 90°. This abrupt change creates a localized gas recirculation zone which decreases the gas stream speed. The one or more ignition sources are preferably located in areas where the speed of the combined reactant stream is lower in order to increase the probability of igniting the combined reactant stream, and where the temperature is lower in order to increase the operating lifetime of the ignition sources. Alternatively a shield can be employed to decrease the speed of the combined reactant stream around the ignition source or to protect it from the radiant heat from the reaction process, increasing its durability. In an alternative approach, the ignition source can be designed so that it can be withdrawn from the chamber. In FIGS. 10a and 10b, two glow plugs 110 and 111 are attached to shell 105 and protrude into the inlet area of reaction chamber 112. These are employed to initiate the reactions during start-up and periodically during operation of SGG 100. Glow plugs 110 and/or 111 can be optionally employed to sense the temperature of reaction chamber 112 at least some of the time, particularly when they are not activated to serve as reaction initiators. This dual purpose for the ignition source, as reaction initiator and temperature sensor, can be used advantageously used in other types of fuel processor as well as those described herein. The use of multiple glow plugs offers the advantage of increased surface area, increasing the probability of ignition during cold startup and redundancy for increased reliability. Alternatively, the ignition source(s) can be located within mixing tube 109 and can be employed to help vaporize and/or ignite the combined reactant stream.

In one method of controlling glow plugs 110 and 111, the oxidant stream flows through SGG 100 for a predetermined time interval prior to energizing (switching on) glow plugs 110 and 111, in order to purge and/or dilute undesirable levels of fuel and/or fuel vapor in reaction chamber 112. Alternatively, a sensor(s) can be employed to detect the levels of fuel and/or fuel vapor within SGG 100 and glow plugs 110 and 111 can be energized after the levels of fuel or fuel vapor fall below a threshold value. The fuel stream is allowed to flow to SGG 100 after the temperature of glow plugs 110 and/or 111 exceeds a threshold value or after a predetermined time interval. This is to increase the probability of ignition of the combined reactant stream. The temperature of glow plugs 110 and 111 can be determined based on the current and voltage supplied to glow plugs 110 and 111. Glow plugs 110 and 111 can be employed during certain operating conditions and/or transient operating conditions, for example, when the flame of the reaction process moves down the reaction chamber 112 or away from mixing tube 109. Employing the glow plugs under these operating conditions can assist in stabilizing the location of the flame of the reaction process in the desired area or stabilize the operation of SGG 100 during transient conditions. Glow plugs 110 and/or 111 can be operated continuously while SGG 100 is operating or the power supplied to the glow plugs 110 and 111 can be reduced, cycled between on and off, and/or switched off during certain operating conditions of SGG 100, or after the temperature of reaction chamber 112 exceeds a threshold value, or after the temperature of glow plugs 110 and/or 111 exceeds a threshold value, in order to extend the life of glow plugs 110 and 111. Glow plugs 110 and/or 111 can be switched off, for example, based on: a predetermined time interval after the flow of the fuel stream to SGG 100 is started, the temperature of SGG 100 exceeding a threshold value or verification of a combustion flame or ignition.

The combined reactant stream flows through reaction chamber 112, where it is converted to a product syngas stream. Carbon particulates can form under certain operating conditions of SGG 100, for example, under fuel-rich conditions. In preferred embodiments, at least a portion of the product syngas stream (which can contain some of the original reactants which have not been converted) flows through a particulate filter 114, housed or integrated within SGG 100, in order to trap the carbon particulates. Particulate filter 114 can offer additional advantages, for example, assisting in mixing of the reactant stream and assisting in flow distribution of the combined reactant stream and/or product syngas stream. Particulate filter 114 can be a monolith structure, such as a wall-flow monolith. In various other embodiments the particulate filter can comprise at least one of the following: a mesh structure; a sintered metal structure; a foam structure; a fibrous structure; an expanded metal structure; a perforated plate structure; and can be constructed from suitable ceramic or metal materials. Preferably particulate filter 114 has a high surface area, low pressure drop, high and wide operating temperature range, and has a high resistance to corrosion. The filter 114 can be configured such that the average speed of the gas stream through particulate filter 114 is about 4 cm/s (1.6 in/s), although higher speeds can be used. The predetermined stream speed allows for trapping of the carbon particulates without excessive pressure drop, while the particulate layer is compacted to a desirable degree to reduce the chances of channel mouth plugging by a bulky particulate layer. This assists in the subsequent carbon combustion, oxidation or gasification process (the term carbon gasification will be used herein to signify any combination of the foregoing processes). Particulate filter 114 can trap and store carbon particulates until the collection of carbon adversely affects the flow of the reactant stream across the filter. A carbon gasification (oxidation) process can be used to regenerate the filter in situ from time to time, and then it will continue to trap carbon particulates. Alternatively, SGG 100 can be operated without a particulate filter. A carbon gasification process can still be employed.

In a preferred method to remove the carbon particulates trapped on particulate filter 114, the carbon particulates are gasified to carbon monoxide (CO) and/or carbon dioxide (CO₂) gas which is then carried away with the product syngas stream. The gasification process can be initiated by adjusting the oxygen-to-carbon ratio (O/C) of SGG 100 to operate in a stoichiometric or fuel-lean condition. Alternatively, SGG 100 can be operated so that a suitable amount of oxygen (O₂) is at least periodically present or introduced into combined reactant stream and/or product syngas stream during fuel-rich operation of SGG 100 to initiate the start and end of the carbon gasification process. The carbon gasification process can be initiated and stopped based upon the operating cycle of the SGG; the operating time of the SGG; pre-determined operating points of the SGG; the operating cycle of the oxidant supply; the operating time of the oxidant supply, and/or predetermined operating points of the oxidant supply or based on measurements of the pressure drop across particulate filter 114 that are compared to pre-determined threshold values. In alternative methods a continuous gasification process can be used.

In FIGS. 10a and 10b, the product syngas stream flows from particulate filter 114 around plug 115, around heat exchanger 102, exiting SGG 100 through outlet conduit 116. Plug 115 directs the flow of the product syngas stream around heat exchanger 102. For certain applications, it can be advantageous to bypass at least a portion of the product syngas stream away from heat exchanger 102 by routing at least a portion of it through plug 115.

SGG 100 is designed for a desired heat loss. Shell 105 can be constructed from thin wall stainless steel material for reduced weight, and encloses ceramic mat 117 and insulation 118. In a preferred embodiment the thermal insulation of SGG 100 comprises a plurality of layers with different thermal conductivity rates (thermal conductivity over a given thickness) over a certain temperature range in order to reduce the volume and cost of the insulation and SGG 100 while maintaining the desired heat loss. A desired thermal conductivity rate and material thickness is selected to obtain the desired thermal conductivity over a temperature range. The thermal conductivity rate and thickness of ceramic mat 117 is different from that of insulation 118. Insulation 118 can be, for example, a vacuum-formed ceramic material. Alternatively a single layer of insulation can be used. Thermocouple 119 and thermocouple 120 are used to monitor the temperature inside SGG 100 in order to control SGG 100. In FIG. 10a, pressure sensors 121 and 122 are employed to detect the pressure differential across particulate filter 114.

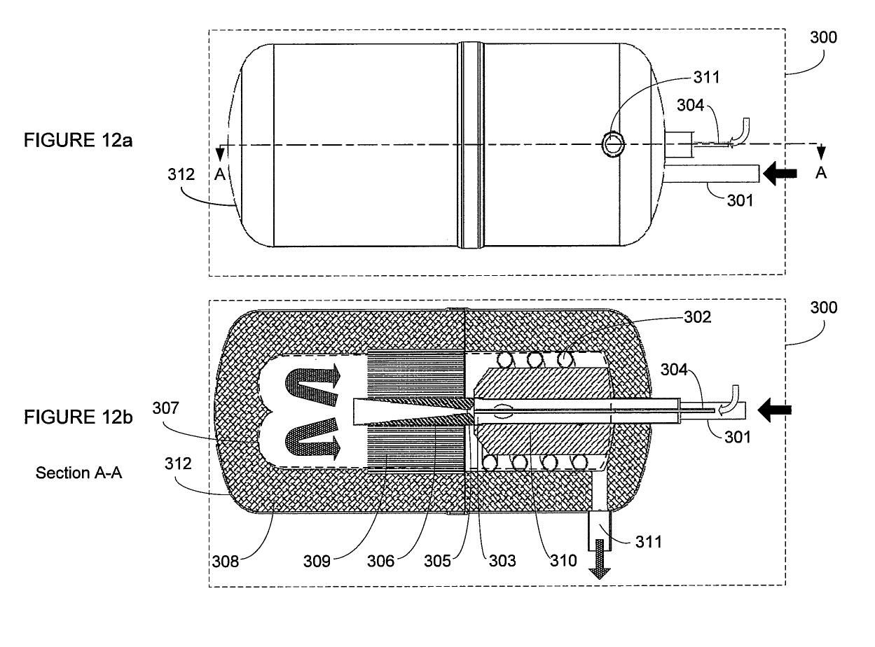

FIG. 12a is a front view while FIG. 12b is a cross-sectional view (along line A-A shown in FIG. 12a) of an alternative embodiment of an SGG. In this design embodiment inlet fuel and oxidant streams flow through substantially axially down the centre of the SGG while the combined reactant stream and then product syngas stream is directed to flow substantially axially in the opposite direction and around the perimeter of a reaction chamber, as indicated by the arrows in FIG. 12b. This is referred to as a turn-around flow design. In FIGS. 12a and 12b, the oxidant stream enters SGG 300 through oxidant inlet conduit 301, flowing through a coiled heat exchanger 302 and into oxidant chamber 303. A fuel stream is introduced via a fuel introduction tube 304 and into oxidant chamber 303. The fuel stream and oxidant stream continue to flow through a CFV 305 and into a mixing tube 306 forming a combined reactant stream. The combined reactant stream then flows into a reaction chamber 307 which is formed and thermally insulated by insulation 308. Insulation 308 can comprise one or more layers of ceramic insulation material with different thermal conductivity and mechanical properties. Insulation 308 is shaped to re-direct or turn around the flow of the combined reactant stream in the opposite direction and near the perimeter of reaction chamber 307. One or more glow plugs (not shown in FIGS. 12a and 12b) are attached to shell 312 and are located in reaction chamber 307 to ignite the reactant stream during start-up and at other operating points of SGG 300. The combustion and then reforming reaction processes occur gradually, and the stream continues through an annular particulate filter 309 where carbon particulates are trapped and stored until a carbon gasification process is initiated, or alternatively are immediately oxidized by a continuous carbon gasification process. The product syngas stream travels around plug 310, around heat exchanger 302 exiting SGG 300 through outlet conduit 311. Alternatively, at least a portion of the product syngas stream can bypass plug 310 and exit SGG 300 through outlet conduit 311.

In preferred embodiments of the apparatus and methods described above, the fuel processor is a syngas generator (SGG) that is a non-catalytic partial oxidation reformer which during normal operation is operated to produce a syngas stream. However, fuel introduction tubes, CFVs, heat exchangers and other components as described herein can be incorporated into various types of fuel processors including SGGs, reformers or reactors used to produce hydrogen-containing gas streams. These can be of various types, for example, catalytic partial oxidizers, non-catalytic partial oxidizers, and/or autothermal reformers.

The fuel supplied to the fuel processor can be a liquid fuel (herein meaning a fuel that is a liquid when under IUPAC defined conditions of standard temperature and pressure) or a gaseous fuel. Fuel introduction tubes are particularly suitable for liquid fuels. A CFV assists in the efficient atomization and vaporization of liquid fuels as described above, therefore its use is also particularly beneficial with a liquid fuel, but a CFV will also provide efficient mixing of gaseous reactant streams. Suitable liquid fuels include, for example, diesel, gasoline, methanol, ethanol or other alcohol fuels, liquefied petroleum gas (LPG), or other liquid fuels from which hydrogen can be derived. Alternative gaseous fuels include natural gas and propane.

The present method and apparatus utilizing a fuel introduction tube is particularly suited to the engine system applications discussed herein, but could also be useful other applications, and could be useful for the introduction of liquid fuel into other hot gaseous reactant streams besides engine exhaust gas streams. Similarly, although the use of a CFV in a fuel processor offers particular advantages when used in an engine system, it could be advantageous to incorporate a CFV into fuel processors for other applications.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. A fuel introduction tube for directing a liquid fuel stream into a hot oxygen-containing reactant stream of a fuel processor, for producing a hydrogen-containing fluid stream, wherein said fuel introduction tube is thermally shielded from said hot oxygen-containing reactant stream.

2. A fuel processor assembly for producing a hydrogen-containing fluid stream, said fuel processor assembly comprising:
(a) an oxidant stream inlet;
(b) at least one fuel introduction tube for directing a liquid fuel stream from a fuel source into said fuel processor;
wherein said fuel introduction tube comprises thermal shielding, for maintaining said liquid fuel stream below about its boiling point while it is passing through said fuel introduction tube during operation of said fuel processor.

3. The fuel processor assembly of claim 2 wherein said thermal shielding comprises a thermal insulating sleeve disposed around said fuel introduction tube.

4. The fuel processor assembly of claim 3 further comprising a mechanism for flowing a thermal shielding fluid between said fuel introduction tube and said sleeve.

5. The fuel processor assembly of claim 2 wherein said introduction tube is capable of functioning as a spark electrode to actuate fuel combustion.

6. A method of operating a fuel processor, said method comprising
(a) introducing a liquid fuel stream into an oxygen-containing gas stream via a fuel introduction tube, wherein the temperature of said oxygen-containing gas stream is above the boiling point of said liquid fuel stream; and
(b) maintaining the fuel stream below its boiling point while it is in said fuel introduction tube.

7. The method of claim 6 wherein said fuel introduction tube is passively thermally shielded from said oxygen-containing gas stream.

8. The method of claim 6 wherein said fuel introduction tube is actively thermally shielded from said oxygen-containing gas stream.

9. The method of claim 8 wherein fuel introduction tube is actively thermally shielded by flowing a shielding fluid in contact with said fuel introduction tube.

10. The method of claim 6 wherein the divergent angle of the fuel stream as it exits said fuel introduction tube is less than about 10° from the longitudinal axis of said fuel introduction tube.

11. The method of claim 6 wherein the liquid fuel stream speed within said fuel introduction tube is between about 0.1 m/s (0.33 ft/s) and about 10.0 m/s (32.8 ft/s).

12. The method of claim 6 wherein the pressure drop across said fuel introduction tube is less that about 690 kpag (100 psig).

13. An engine system comprising:
(a) a liquid fuel source;
(b) a combustion engine connected to receive a fuel stream from said liquid fuel source, said combustion engine comprising an exhaust stream outlet; and
(c) a fuel processor for producing a hydrogen-containing fluid stream, said fuel processor comprising:
(i) an oxidant stream inlet fluidly connected to said engine exhaust stream outlet, such that at least a portion of said engine exhaust stream is directed to said fuel processor oxidant stream inlet during operation of said combustion engine;
(ii) at least one fuel introduction tube for directing a liquid fuel stream from said fuel source into said engine exhaust stream.

14. The engine system of claim 13 wherein said at least one fuel introduction tube is thermally shielded from said engine exhaust stream.

15. The engine system of claim 13 wherein said at least one fuel introduction tube has an active thermal shielding mechanism associated therewith.

16. The engine system of claim 13 wherein said active thermal shielding mechanism further comprises apparatus for flowing a thermal shielding fluid in contact with said fuel introduction tube.

17. A method of operating an engine system, said engine system comprising a combustion engine and a fuel processor, said method comprising:
(a) directing an engine fuel stream and an oxidant stream to said combustion engine and operating said combustion engine to produce an engine exhaust stream;
(b) directing at least a portion of said engine exhaust stream to said fuel processor;
(c) introducing a liquid fuel stream into said engine exhaust stream via a fuel introduction tube, to form a combined reactant stream;
(d) operating said fuel processor to produce a hydrogen-containing gas stream from said combined reactant stream.

18. The method of claim 17 wherein at least some of the time during operation of said engine system, the temperature of said engine exhaust stream is higher than the boiling point of said liquid fuel stream.

19. The method of claim 17 wherein the temperature of said liquid fuel is maintained below its boiling point within said fuel introduction tube by thermally shielding said fuel introduction tube.

20. The method of claim 19 wherein thermally shielding said fuel introduction tube comprises flowing a thermal shielding fluid in contact with said fuel introduction tube.

21. The method of claim 17 wherein the degree of fuel stream atomization occurring as said liquid fuel stream is introduced into said engine exhaust stream via said introduction tube is substantially independent of the pressure of the liquid fuel stream supplied to said fuel introduction tube.

22. The method of claim 17 wherein the degree of fuel stream atomization occurring as said liquid fuel stream is introduced into said engine exhaust stream via said at least one introduction tube is substantially unaffected by the liquid fuel stream mass flow rate through said fuel introduction tube.

23. The method of claim 17 further comprising at least periodically directing a supplemental air stream to said fuel processor wherein said fuel processor is operated to produce said hydrogen-containing gas stream from said combined stream and said supplemental air stream.

24. The method of claim 17 wherein said engine fuel stream is drawn from the same source as said liquid fuel stream that is directed to said fuel processor.

25. The method of claim 17 further comprising, prior to ceasing operating said fuel processor, directing a gas stream through said fluid introduction tube to purge said liquid fuel stream from said tube.

26. A method of operating a fuel processor, said method comprising directing a reactant stream through a venturi for downstream conversion within said fuel processor, wherein at least a portion of the time during operation of said fuel processor to produce a hydrogen-containing gas stream, said reactant stream is choked as it passes through said venturi.

27. The method of claim 26 wherein said at least a portion of time is a predominant portion of the time.

28. The method of claim 26 wherein said reactant stream is choked as it passes through said venturi at least 85% of the time during operation of said fuel processor to produce a hydrogen-containing gas stream.

29. The method of claim 26 wherein the speed of said reactant stream through said venturi is in the range from about 300 m/s (984 ft/s) to about 700 m/s (2,297 ft/s).

30. The method of claim 26 wherein said reactant stream is a mixture comprising a fuel stream and an oxidant stream.

31. The method of claim 30 wherein said fuel stream is a liquid when at standard temperature and pressure.

32. The method of claim 30 wherein a predominant portion of the time during operation of said fuel processor, the speed of said reactant stream through said venturi is greater than the flame speed of said mixture.

33. The method of claim 26 wherein said oxidant stream comprises engine exhaust gas from a combustion engine.

34. The method of claim 26 wherein said reactant stream comprises an oxidant stream and wherein the supply of said oxidant stream to said fuel processor is passively metered by directing it through said venturi.

35. The method of claim 26 wherein said reactant stream that is directed through said venturi comprises substantially all of the oxidant stream that is supplied to said fuel processor during operation thereof.

36. A fuel processor for producing a hydrogen-containing gas stream, said fuel processor comprising a unitary device capable of metering a reactant stream supplied to said fuel processor, mixing a fuel stream with an oxidant stream, and arresting flashback from downstream combustion of said mixed fuel stream and oxidant stream within said fuel processor.

37. The fuel processor of claim 36 wherein said unitary device is a venturi capable of operating as a critical flow venturi.

38. A fuel processor for producing a hydrogen-containing gas stream, said fuel processor comprising:
(a) a venturi having a convergent inlet section and a throat;
(b) a divergent section located downstream of said venturi throat; and
(c) a step that forms a discontinuity between said throat and said divergent outlet section.

39. The fuel processor of claim 38 wherein said divergent section and said step are part of said venturi.

40. The fuel processor of claim 38 wherein said fuel processor further comprises a mixing tube located downstream of said venturi, and wherein said divergent section is part of said mixing tube.

41. The fuel processor of claim 40 wherein said step is at an interface between said venturi and said mixing tube.

42. An engine system comprising:
(a) a fuel source;
(b) a combustion engine connected to receive a fuel stream from said fuel source, said combustion engine comprising an exhaust stream outlet; and
(c) a fuel processor for producing a hydrogen-containing gas stream, said fuel processor comprising a venturi fluidly connected to said engine exhaust stream outlet, such that at least a portion of said engine exhaust stream can be directed to said fuel processor via said venturi during operation of said combustion engine.

43. The engine system of claim 42 wherein said venturi is also fluidly connected to receive a fuel stream from said fuel source.

44. The engine system of claim 42 wherein said venturi is capable of operating as a critical flow venturi.

45. The engine system of claim 42 wherein there is no flow metering device between said exhaust stream outlet and said venturi for controlling the flow rate of engine exhaust stream directed to said fuel processor.

46. The engine system of claim 42 wherein said fuel processor comprises a single oxidant stream inlet located upstream of said venturi.

47. The engine system of claim 42 wherein said venturi is capable of passively metering the supply of said engine exhaust stream to said fuel processor.

48. The engine system of claim 43 wherein said venturi is capable of mixing said engine exhaust stream and said fuel stream.

49. The engine system of claim 43 wherein said venturi is capable of arresting flashback from downstream combustion of said engine exhaust stream and said fuel stream within said fuel processor.

50. The engine system of claim 43 further comprising an exhaust after-treatment subsystem, and wherein said fuel processor is a syngas generator that is connected to at least intermittently supply said hydrogen-containing gas stream to said exhaust after-treatment subsystem.

51. A fuel processor for producing a product stream from a fuel stream and an oxidant stream, said fuel processor comprising a fuel inlet port, an oxidant inlet port, a product outlet port, and an outer shell housing a reaction chamber, wherein said fuel processor further comprises:
(a) a critical flow venturi fluidly connected to receive said oxidant stream from said oxidant inlet port; and
(b) a heat exchanger fluidly connected between said oxidant inlet port and said critical flow venturi for transferring heat from said product stream to said oxidant stream upstream of said critical flow venturi.

52. The fuel processor of claim 51 wherein said heat exchanger is located at least partially within said reaction chamber.

53. The fuel processor of claim 51 wherein said heat exchanger comprises a coiled tube located at least partially within said reaction chamber.

54. The fuel processor of claim 52 further comprising a mixing tube located downstream of said critical flow venturi, at least one of said critical flow venturi and said mixing tube comprising a divergent section.

55. The fuel processor of claim 54 wherein said mixing tube comprises thermal shielding for thermally shielding said mixing tube from said reaction chamber.

56. The fuel processor of claim 55 wherein said thermal shielding comprises a thermal insulating sleeve disposed around said mixing tube.

57. The fuel processor of claim 55 wherein said thermal shielding comprises an active thermal shielding mechanism associated with said mixing tube.

58. The fuel processor of claim 54 further comprising a bluff body located at least partially in said mixing tube near the entrance to said reaction chamber.

59. The fuel processor of claim 51 further comprising at least one shielded ignition source.

60. The fuel processor of claim 51 further comprising a filter for trapping carbon particulates, said filter housed within said outer shell and located at least partially within or downstream of said reaction chamber.

61. The fuel processor of claim 51, further comprising thermal insulation comprising a plurality of layers with different thermal conductivity rates.

62. The fuel processor of claim 51, further comprising thermal insulation comprising a vacuum-formed material.

63. The fuel processor of claim 51 wherein said fuel processor is a syngas generator.

64. A method of operating a fuel processor to produce a product stream, said method comprising:
(a) introducing an oxidant stream into said fuel processor;
(b) directing said oxidant stream through a heat exchanger in which heat is transferred from said product stream to said oxidant stream to produce a pre-heated oxidant stream;
(c) directing said pre-heated oxidant stream through a venturi, wherein at least a portion of the time during operation of said fuel processor, said venturi is choked;
(d) introducing a fuel stream into said pre-heated oxidant stream to produce a combined reactant stream;
(e) converting said combined reactant stream to said product stream within a reaction chamber in said fuel processor.

65. The method of claim 64 wherein during step (b) said oxidant stream flows through said heat exchanger in an essentially co-flow direction in relation to said product stream.

66. The method of claim 64 wherein said fuel stream is introduced into said pre-heated oxidant stream upstream of the throat of said venturi, whereby said combined stream is directed through said venturi.

67. The method of claim 64 wherein in step (c) said at least a portion of time is a predominant portion of the time.

68. The method of claim 64 wherein said fuel is a liquid fuel.

69. The method of claim 64 wherein said combined reactant stream is directed to said reaction chamber via a mixing tube, wherein said mixing tube houses a sonic shock wave when said venturi is choked.

70. The method of claim 64 wherein said combined reactant stream is directed past a bluff body into said reaction chamber.

71. The method of claim 64 wherein said oxidant stream comprises exhaust gas from an internal combustion engine.

72. The method of claim 64 further comprising directing said product stream through a filter to trap carbon particulates, said filter located within said fuel processor.

73. The method of claim 64 further comprising at least periodically gasifying said carbon particulates thereby cleaning said filter.

74. The method of claim 64 further comprising using at least one ignition source to ignite said combined reactant stream within fuel processor, wherein said ignition source is activated at least periodically during operation of said fuel processor to stabilize the location of the flame of the combined reactant stream.

75. An engine system comprising a combustion engine, at least one exhaust after-treatment device and the fuel processor of claim 51, wherein said oxidant inlet port is connected to receive exhaust gas from said engine, and said product outlet port is connected to at least periodically supply said product stream to said at least one exhaust after-treatment device.
